(19) United States
(12) Patent Application Publication
(10) Pub. No.: US 2024/0265427 A1
(43) Pub. Date: Aug. 8, 2024

(54) PERSONALIZATION FROM SEQUENCES AND REPRESENTATIONS IN ADS

(71) Applicant: ETSY, INC., Brooklyn, NY (US)

(72) Inventors: Denisa Anca Olteanu Roberts, New York, NY (US); Alaa Mohamed Awad, Brooklyn, NY (US); Andrea Laura Heyman, New York, NY (US); Eden Dolev, New York, NY (US); Marcin Mejran, Long Island City, NY (US); Zoe Frances Weil, Long Island City, NY (US); Zahra Ebrahimzadeh, Huntington Beach, CA (US); Mahir Yavuz, Brooklyn, NY (US); Vaibhav Malpani, New York, NY (US)

(73) Assignee: ETSY, Inc., Brooklyn, NY (US)

(21) Appl. No.: 18/390,738

(22) Filed: Dec. 20, 2023

Related U.S. Application Data
(60) Provisional application No. 63/482,627, filed on Feb. 1, 2023.

(51) Int. Cl. G06Q 30/0251; G06Q 30/0272

(52) U.S. Cl. CPC G06Q 30/0271; G06Q 30/0272

(57) ABSTRACT

Aspects of the disclosure provide a computer-implemented method for generating personalized results. The method includes identifying a set of user actions by a specific user within a sliding window of time, generating a first representations for the set of user actions using an encoder component of a personalization module, generating a second representation for the set of user actions using a pretrained representations component of the personalization module, generating a third representation for the set of user actions using a learned representations component of the personalization module, using the personalization module to combine the first representation, second representation and the third representation to generate a short-term personalized representation for the specific user, and providing a set of results for display to the user based on the short-term personalized representation.

### CROSS REFERENCE

The present application claims the benefit of the filing date of U.S. Provisional Patent Application No. 63/482,627 filed Feb. 1, 2023, the disclosures of which are hereby incorporated herein by reference.

### BACKGROUND

Various online marketplaces bring together buyers and sellers (e.g., E-commerce websites). Providing sellers with tools to market their goods, services, and virtual “shops” for selling such goods and services is critical to the success of such sellers. Advertisements or ads may be used with such marketplaces to supplement search results with ads for relevant listings for goods or services. In this regard, sellers may sponsor ads which promote their listings through auction campaigns which rely on ranking and bidding systems. In the “pay-per-click” model, advertisers are charged for clicks. Thus, sponsored search systems have an incentive to engage users via accurate real-time predictions of clicks and purchases. These ranking and bidding systems, in turn, rely on accurate real-time predictions of the probability that a user of the marketplace will click on a given sponsored ad for a seller's listing based on that ad's context.

### SUMMARY

Aspects of the disclosure provide a computer-implemented method. The method includes identifying, by one or more processors of a server computing device, a set of user actions by a user within a sliding window of time; generating, by the one or more processors, a first representation for the set of user actions using an encoder component of a personalization module; generating, by the one or more processors, a second representation for the set of user actions using a pretrained representations component of the personalization module; generating, by the one or more processors, a third representation for the set of user actions using a learned representations component of the personalization module; using, by the one or more processors, the personalization module to combine the first representation, second representation and the third representation to generate a short-term personalized representation for the user; and providing, by the one or more processors, a set of results for display to the user based on the short-term personalized representation.

In one example, the user actions include one or more of search queries, item favorites, listing views, items added to a cart of the user, or one or more past purchases. In another example, the method also includes inputting the short-term personalized representation into one or more personalized downstream models in order to generate a value and ranking the set of results based on the value. In this example, the ranked set of results is provided for display to the user. In addition, the one or more personalized downstream models includes a first model that generates a predicted probability that a particular listing will be clicked. In addition, the one or more personalized downstream models further include a second model that generates a predicted conditional probability that a good or service represented by a listing will be purchased. In another example, the personalization module is implemented as a Tensorflow Keras layer. In another example, the method also includes determining a length of the sliding window based on a location of the user. In another example, the method also includes determining a length of the sliding window based on a type of listing selected by the user within the sliding window. In another example, the sliding window is no more than 1 hour. In another example, the set of user actions is limited in number according to a maximum sequence length. In another example, the encoder component includes a transformer encoder. In this example, the encoder component is implemented as an importable Keras layer which encodes sequences of listings. In another example, the pretrained representations component is configured to encode sequences of user actions within the sliding window. In another example, the pretrained representations component is configured to encode sequences of search queries within the sliding window as text representations. In this example, the text representations are Skip-gram text representations. In another example, the pretrained representations component is configured to encode sequences of listing identifiers within the sliding window as multimodal representations. In another example, the pretrained representations component is configured to encode sequences of listing identifiers within the sliding window as visual representations. In another example, the pretrained representations component is configured to encode sequences of listing identifiers within the sliding window as Skip-gram listing representations. In another example, the learned representations component is configured as a look-up table.

Another aspect of the disclosure provides a computer system configured to generate personalized results. The computer system includes memory configured to store a set of user actions and one or more processors operatively coupled to the memory. The one or more processors are configured to identify a set of user actions by a user within a sliding window of time; generate a first representation for the set of user actions using an encoder component of a personalization module; generate a second representation for the set of user actions using a pretrained representations component of the personalization module; generate a third representation for the set of user actions using a learned representations component of the personalization module; use the personalization module to combine the first representation, second representation and the third representation to generate a short-term personalized representation for the user; and provide a set of results for display to the user based on the short-term personalized representation.

### BRIEF DESCRIPTION OF THE DRAWINGS

FIGS. 1A-B illustrate an example computer system that may be employed with aspects of the technology.

FIG. 2 is an example transformer-type neural network architecture that may be employed with aspects of the technology.

FIG. 3 illustrates an example representation of a diversifiable personalization module in accordance with aspects of the technology.

FIG. 4 illustrates example representations of listings in accordance with aspects of the disclosure.

FIG. 5 illustrates an example training architecture for generating representations in accordance with aspects of the disclosure.

FIG. 6 illustrates an example training architecture for generating representations in accordance with aspects of the disclosure.

FIG. 7 illustrates an example functional diagram for ranking ads or search results in accordance with aspects of the technology.

FIG. 8A-8B illustrates examples of personalized models in accordance with aspects of the disclosure.

FIG. 9 illustrates an example of ads displayed to a user without personalized ranking and with personalized rankings in accordance with aspects of the technology.

FIG. 10 is a flow diagram in accordance with aspects of the disclosure.

FIG. 11 illustrates comparisons of different configurations of personalized models in accordance with aspects of the disclosure.

FIG. 12 illustrates example results of ablation studies in accordance with aspects of the disclosure.

FIG. 13 illustrates example results of ablation studies in accordance with aspects of the disclosure.

FIG. 14 illustrates example results of ablation studies in accordance with aspects of the disclosure.

FIG. 15 illustrates example hyperperameters for model training in accordance with aspects of the disclosure.

FIG. 16 illustrates example train and validation datasets in accordance with aspects of the disclosure.

FIG. 17 illustrates example comparison of metrics between baseline and personalized models in accordance with aspects of the disclosure.

FIG. 18 illustrates example test results in accordance with aspects of the disclosure.

FIG. 19 illustrates example hyperperameters for model training in accordance with aspects of the disclosure.

FIG. 20 illustrates example dataset choices for model training in accordance with aspects of the disclosure.

FIG. 21 illustrates example metrics for example dataset size choices for model training in accordance with aspects of the disclosure.

FIG. 22 illustrates example metrics for train and validation loss curves in accordance with aspects of the disclosure.

FIG. 23 illustrates example comparison of metrics between baseline and personalized models in accordance with aspects of the disclosure.

FIG. 24 illustrates example data in accordance with aspects of the disclosure.

FIG. 25 illustrates example hyperparameter settings in accordance with aspects of the disclosure.

FIG. 26 illustrates an example comparison of data in accordance with aspects of the disclosure.

FIG. 27 presents another set of illustrates example performance results in accordance with aspects of the disclosure.

FIG. 28 illustrates example results in accordance with aspects of the disclosure.

FIG. 29 illustrates example test results in accordance with aspects of the disclosure.

FIG. 30 illustrates example data in accordance with aspects of the disclosure.

### DETAILED DESCRIPTION

### Overview

Aspects of the technology involve generating short-term user representations based on a diversifiable personalization module. Such representations may in effect be used to generate personalized ads through encoding and learning from short-term sequences of user actions and diverse representations on E-commerce websites. A custom transformer encoder architecture learns the inherent structure from the sequence of actions that happened within a sliding-window from the most recent user action, and visual, multimodal and textual representations enrich that signal.

To this end, a diversifiable personalization module (ADPM) may be used to personalize downstream models for individual users. Examples of downstream models may include Click-Through Rate (CTR) and Post-Click Conversion Rate (PCCVR) baseline models used in rankings for sets of results including sponsored ads, search results, or other types of results or recommendations. CTR baseline models may be generic models which are configured to generate a predicted probability that a particular listing will be clicked, while PCCVR baseline models may be generic models which are configured to generate a predicted conditional probability that a good or service represented by the listing will be purchased. These may be combined into a value score which can be used to sort and determine an order of results in a set of results including sponsored ads or search results. For example, the CTR and PCCVR baseline models may be binary classification deep neural network models trained using cross entropy loss to output whether an ad was clicked or purchased. Each model may take as input data about an ad that was displayed to a user and data about the context in which the user interacted with that ad such as: on which page the user is browsing, which platform (e.g., which browser or device), time of day, geographic location, language preference, et. As a result, the models may be designed to output a probability that an ad will be purchased by a user given the aforementioned context. These “non-personalized” CTR and PCCVR baseline models may be further trained in order to be personalized to individual users using the ADPM.

The ADPM may be implemented as a custom Tensorflow Keras layer that may be reusable across personalization use-cases. In this regard, the ADPM may be a highly configurable module which can encode sequences of user actions or user behavioral data for a specific user and derive a short-term user representation for that specific user. The ADPM includes customizable components such as an encoder component, a pretrained representations component, and a learned representations component. These components may be used to encode different signals or sequences of user actions of a particular user captured within a sliding window of time as discussed further below in order to provide the maximum impact on a short-term representation for that particular user. These may be concatenated in order to generate the short-term user representation which as noted above may be used to generate personalized CTR and PCCVR predictions using personalized CTR and PCCVR models.

The user behavioral data may include actions by a specific user such as search queries, item favorites, listing views, items (e.g., goods or services) added to the specific user's cart, past purchases, or implicit feedback. The ADPM may utilize a set of user behavioral data generated during a sliding window of, for example 30 minutes, an hour, 2 hours, or more or less for the specific user. In this regard, the set may include no user actions, one user action or a plurality of user actions depending on the circumstances of that user's current behavior without relying on an arbitrary number of actions (e.g., the last 4, 5, 10, 20, 100, etc., actions). In many cases the arbitrary number of actions may depend upon typical user actions at an E-commerce website where the user behavioral data was collected (the last 20 actions may have occurred over the course of several months at one E-commerce website or in the last five minutes at another E-commerce website). In that regard, the sliding-window of time may be better able to capture relevant user actions over a plurality of different types of websites.

The sliding window may be adjusted in some circumstances, for example, based on the current location of the specific user (e.g., GPS location, location via IP address, or some other location) and/or the types of listings the specific user has selected within the sliding window. For example, in some states or countries users may spend more time browsing certain types of goods or services before making a purchase. In other examples, some users may spend more time browsing before making a purchase on higher-cost goods or services versus lower-cost goods or services. In some instances, the number of user actions within the sliding window may be limited in number to some maximum sequence length, such as 50 actions or more or less which may be determined based on semantics, infrastructure constraints, latency requirements or other considerations.

The encoder component may be configured as a transformer encoder which includes a max pooling layer. In this regard, the encoder component may be implemented as an importable Keras layer (such as PyTorch, MXNet, etc.) which encodes short-term sequences of different listings within the aforementioned window into representations. Each listing may be represented by a listing identifier or “listing ID”. These may be padded and masked to a common length corresponding to the maximum sequence length. The resulting representations may thus encode both the content and position of the sequence of user actions. Using a transformer encoder may capture inter-item (e.g., inter-listing) dependencies while also accounting for the sequence ordering of those listings. Thus, the result may be very expressive representations of the specific user actions within the sliding window.

The pretrained representations component may be configured to encode sequences of user actions within the aforementioned window to generate additional representations. These representations may encode diverse features such as image, price, color, category, semantic text. Other pretrained representations may also be used for different use cases. For instance, sequences of recent search queries may be concatenated and encoded using fine-tuned text representations such as Skip-gram text representations. Sequences of listing IDs may be encoded as multimodal representations using pretrained multimodal (AIR) representations, as visual representations, and/or as interaction-based representations such as Skip-gram listing representations. Such representations may be useful for feature encoding, scalability and modularity. The pretrained representations component may be key for configurability and scalability of the ADPM.

The learned representations component may be configured to generate representations learned for a sequence of user actions within the aforementioned window in its own vector space. These representations may embed short-term sequences in the space for the given task in which the representations are used. Two example tasks may include clicks (CTR) and purchase predictions (PCCVR). For such tasks, the learned representations component may embed the sequence of listing IDs from the sliding window in the space of click and purchase probability. The learned representations component may be implemented as a look-up table such as a Keras look-up table.

The short-term user representations may then be used as inputs to personalized downstream models. For example, the short-term representations may be used to train non-personalized CTR and PCCVR baseline models in order to result in personalized CTR and PCCVR models. For instance, the short-term user representations may be concatenated with additional input representations which may include query, listing and context representations and input into the personalized downstream models. The outputs of the personalized downstream models may then be used to rank a set of results including sponsored ads or search results, other types of results, or recommendations. The resulting ranked set of results may then be provided for display to the specific user.

The features described herein may provide for the generation of short-term user representations based on a diversifiable personalization module. Because the ADPM relies on a sliding window of most recent user actions, the resulting personalized representations and ranked ads or search results generated for each individual user may have the most relevance to that individual user at that time. In this regard, ADPM's use of a plurality of different components, provides diversity of representations which improves overall performance of predictions of future user behavior. For instance, when used in conjunction with various downstream models, such as CTR and PCCVR, these models outperform the non-personalized CTR and PCCVR baseline models (e.g., without ADPM) by +2.66% and +2.42%, respectively, in offline Area Under the Receiver Operating Characteristic Curve (ROC-AUC), as well as in online metrics. In addition, although marked improvements in CTR and PCCVR predictions, because ADPM is highly configurable, it can be scaled to many different types of downstream tasks while at the same time introducing a per-model customization without sacrificing performance.

### Example Systems

### Example Computing Architecture

Model training and inference may be performed on one or more tensor processing units (TPUs), CPUs or other computing architectures in order to implement the technical features disclosed herein.

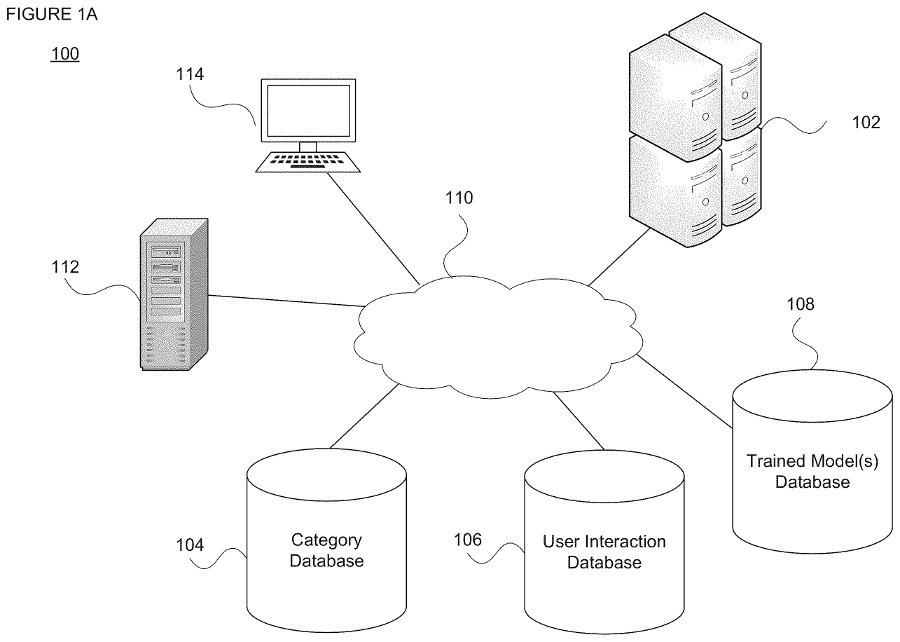

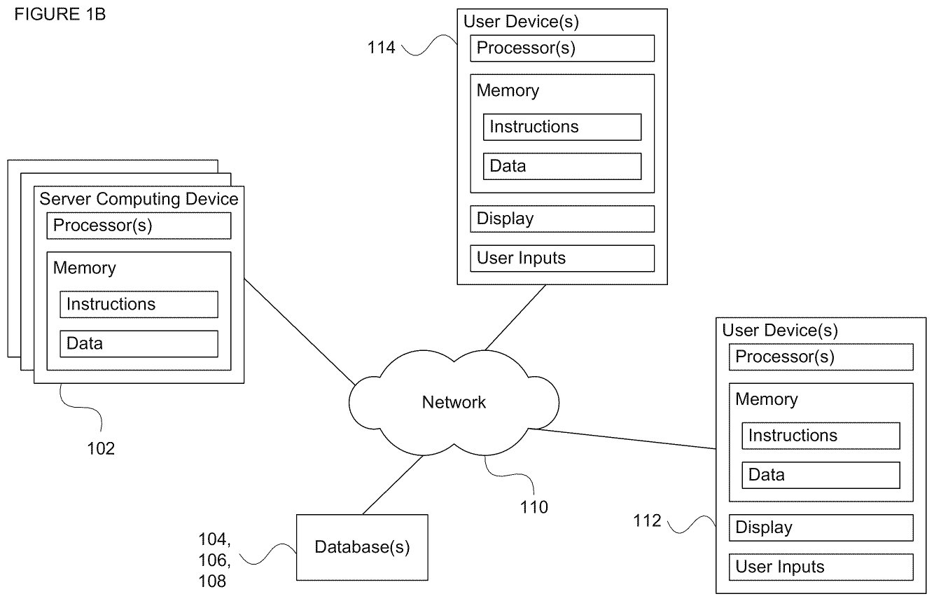

An example computing architecture is shown in FIGS. 1A and 1B. In particular, FIGS. 1A and 1B are pictorial and functional diagrams, respectively, of an example system 100 that includes a plurality of computing devices and databases connected via a network. For instance, computing device(s) 102 may be a server 102 configured as a single server computing device, a server farm or a cloud-based server system.

Storage systems 104, 106, 108 may store, e.g., a corpus of goods and/or services in multiple categories (e.g., maintained in a structured taxonomy with corresponding category identifiers), a corpus of user action or user behavior data that may be associated with one or more categories, and one or more trained models as discussed further below. Such storage systems may be configured the same or similar to the memory of the server 102. In some instances, the storage systems may store information in various databases. This user behavioral data may include user actions such as search queries, item favorites, listing views, items (e.g., goods or services) added to the specific user's cart, past purchases, or implicit feedback. The trained models may include, for example, a diversifiable personalization module (ADPM) as well as personalize downstream models as discussed further below.

The server 102 may access the databases via network 110. One or more user devices or systems may include a computing device 112 and a desktop computing device 114, for instance to provide user interactions (e.g., browsing, clicking, purchasing and/or subscribing actions) and/or other information to the computing device(s) 102. Other types of user devices, such as mobile phones, tablet PCs, smartwatches, head-mounted displays and other wearables, etc., may also be employed.

As shown in FIG. 1B, each of the computing devices 102, 112, 114 may include one or more processors, memory, data and instructions. The memory stores information accessible by the one or more processors, including instructions and data (e.g., machine translation model, parallel corpus information, feature extractors, etc.) that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing, whereby different portions of the instructions and data are stored on different types of media.

The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs, TPUs, etc. Alternatively, each processor may be a dedicated device such as an ASIC or other hardware-based processor. Although FIG. 1B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server 102. Accordingly, references to a processor or computing device will be understood to include references to a collection of processors or computing devices or memories that may or may not operate in parallel.

The data, such as category and/or user interaction information, may be operated on by the system to train one or more personalized models as discussed further below. This can include augmenting certain information from the datasets. The trained models may be used to provide and display product or service recommendations, and/or ads to one or more users, for instance users of computing devices 112 and/or 114.

The computing devices may include all of the components normally used in connection with a computing device such as the processor and memory described above as well as a user interface subsystem for receiving input from a user and presenting information to that user (e.g., text, imagery and/or other graphical elements). The user interface subsystem may include one or more user inputs (e.g., at least one front (user) facing camera, a mouse, keyboard, touch screen and/or microphone) and one or more display devices (e.g., a monitor having a screen or any other electrical device that is operable to display information (e.g., text, imagery and/or other graphical elements). Other output devices, such as speaker(s) may also provide information to users.

The computing devices (e.g., 112, 114) of the users may communicate with a back-end computing system (e.g., server 102) via one or more networks, such as network 110. The network 110, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, server 102 may include one or more server computing devices having a plurality of computing devices, e.g., a load balanced server farm or cloud computing system, that exchange information with different nodes of a network for the purpose of receiving, processing and transmitting the data to and from other computing devices. For instance, server 102 may include one or more server computing devices that are capable of communicating with any of the computing devices 112-114 via the network 110.

### General Transformer Arrangement

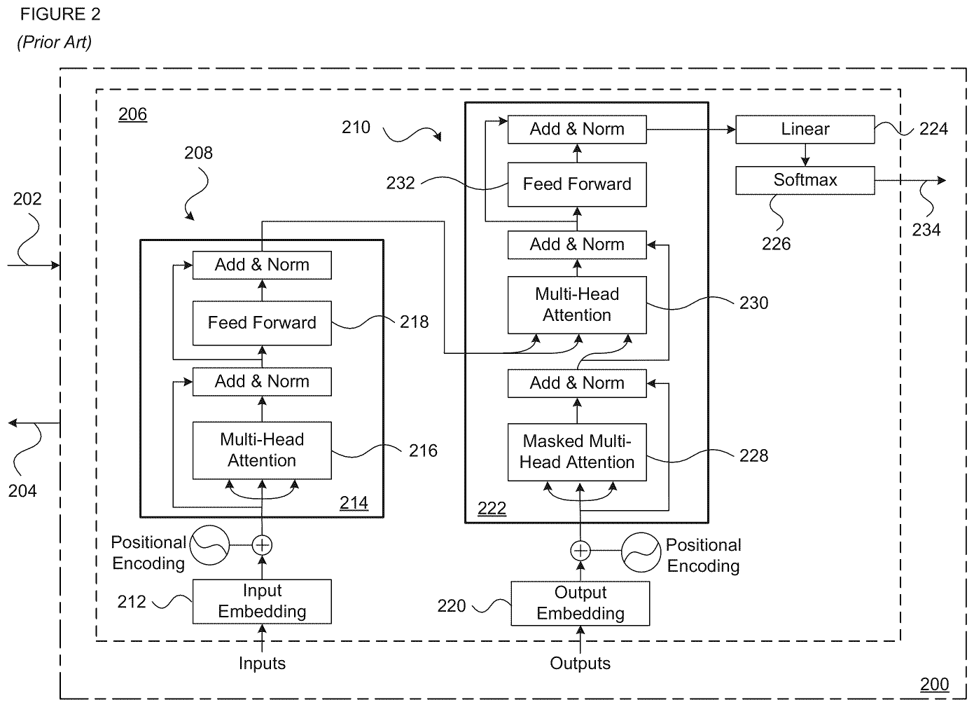

The technology discussed in this application may employ one or more neural networks, each having a self-attention architecture. The Transformer neural network may have an encoder-decoder architecture. An example Transformer-type architecture is shown in FIG. 2. System 200 of FIG. 2 is implementable as computer programs by processors of one or more computers in one or more locations. The system 200 receives an input sequence 202 and processes the input sequence 202 to transduce the input sequence 202 into an output sequence 204. The input sequence 202 has a respective network input at each of multiple input positions in an input order and the output sequence 204 has a respective network output at each of multiple output positions in an output order.

System 200 can perform any of a variety of tasks that require processing sequential inputs to generate sequential outputs. System 200 includes an attention-based sequence transduction neural network 206, which in turn includes an encoder neural network 208 and a decoder neural network 210. The encoder neural network 208 is configured to receive the input sequence 202 and generate a respective encoded representation of each of the network inputs in the input sequence. An encoded representation is a vector or other ordered collection of numeric values. The decoder neural network 210 is then configured to use the encoded representations of the network inputs to generate the output sequence 204. Generally, both the encoder 208 and the decoder 210 are attention-based. In some cases, neither the encoder nor the decoder includes any convolutional layers or any recurrent layers. The encoder neural network 208 includes an embedding layer (input embedding) 212 and a sequence of one or more encoder subnetworks 214. The encoder neural network 208 network may include N number of encoder subnetworks 214.

The embedding layer 212 is configured, for each network input in the input sequence, to map the network input to a numeric representation of the network input in an embedding space, e.g., into a vector in the embedding space. The embedding layer 212 then provides the numeric representations of the network inputs to the first subnetwork in the sequence of encoder subnetworks 214. The embedding layer 212 may be configured to map each network input to an embedded representation of the network input and then combine, e.g., sum or average, the embedded representation of the network input with a positional embedding of the input position of the network input in the input order to generate a combined embedded representation of the network input. In some cases, the positional embeddings are learned. As used herein, “learned” means that an operation or a value has been adjusted during the training of the sequence-based transduction neural network 206. In other cases, the positional embeddings may be fixed and are different for each position.

The combined embedded representation is then used as the numeric representation of the network input. Each of the encoder subnetworks 214 is configured to receive a respective encoder subnetwork input for each of the plurality of input positions and to generate a respective subnetwork output for each of the plurality of input positions. The encoder subnetwork outputs generated by the last encoder subnetwork in the sequence are then used as the encoded representations of the network inputs. For the first encoder subnetwork in the sequence, the encoder subnetwork input is the numeric representations generated by the embedding layer 212, and, for each encoder subnetwork other than the first encoder subnetwork in the sequence, the encoder subnetwork input is the encoder subnetwork output of the preceding encoder subnetwork in the sequence.

Each encoder subnetwork 214 includes an encoder self-attention sub-layer 216. The encoder self-attention sub-layer 216 is configured to receive the subnetwork input for each of the plurality of input positions and, for each particular input position in the input order, apply an attention mechanism over the encoder subnetwork inputs at the input positions using one or more queries derived from the encoder subnetwork input at the particular input position to generate a respective output for the particular input position. In some cases, the attention mechanism is a multi-head attention mechanism as shown. In some implementations, each of the encoder subnetworks 214 may also include a residual connection layer that combines the outputs of the encoder self-attention sub-layer with the inputs to the encoder self-attention sub-layer to generate an encoder self-attention residual output and a layer normalization layer that applies layer normalization to the encoder self-attention residual output. These two layers are collectively referred to as an “Add & Norm” operation in FIG. 2.

Some or all of the encoder subnetworks can also include a position-wise feed-forward layer 218 that is configured to operate on each position in the input sequence separately. In particular, for each input position, layer 218 is configured to receive an input at the input position and apply a sequence of transformations to the input at the input position to generate an output for the input position. The inputs received by the layer 218 can be the outputs of the layer normalization layer when the residual and layer normalization layers are included or the outputs of the encoder self-attention sub-layer 216 when the residual and layer normalization layers are not included. The transformations applied by layer 218 will generally be the same for each input position (but different feed-forward layers in different subnetworks may apply different transformations).

In cases where an encoder subnetwork 214 includes a position-wise feed-forward layer 218 as shown, the encoder subnetwork can also include a residual connection layer that combines the outputs of the position-wise feed-forward layer with the inputs to the position-wise feed-forward layer to generate an encoder position-wise residual output and a layer normalization layer that applies layer normalization to the encoder position-wise residual output. As noted above, these two layers are also collectively referred to as an “Add & Norm” operation. The outputs of this normalization layer can then be used as the outputs of the encoder subnetwork 214.

Once the encoder neural network 208 has generated the encoded representations, the decoder neural network 210 is configured to generate the output sequence in an auto-regressive manner. That is, the decoder neural network 210 generates the output sequence, by at each of a plurality of generation time steps, generating a network output for a corresponding output position conditioned on (i) the encoded representations and (ii) network outputs at output positions preceding the output position in the output order. In particular, for a given output position, the decoder neural network generates an output that defines a probability distribution over possible network outputs at the given output position. The decoder neural network can then select a network output for the output position by sampling from the probability distribution or by selecting the network output with the highest probability.

Because the decoder neural network 210 is auto-regressive, at each generation time step, the decoder network 210 operates on the network outputs that have already been generated before the generation time step, i.e., the network outputs at output positions preceding the corresponding output position in the output order. In some implementations, to ensure this is the case during both inference and training, at each generation time step the decoder neural network 210 shifts the already generated network outputs right by one output order position (i.e., introduces a one position offset into the already generated network output sequence) and (as will be described in more detail below) masks certain operations so that positions can only attend to positions up to and including that position in the output sequence (and not subsequent positions). While the remainder of the description below describes that, when generating a given output at a given output position, various components of the decoder neural network 210 operate on data at output positions preceding the given output positions (and not on data at any other output positions), it will be understood that this type of conditioning can be effectively implemented using shifting.

The decoder neural network 210 includes an embedding layer (output embedding) 220, a sequence of decoder subnetworks 222, a linear layer 224, and a softmax layer 226. In particular, the decoder neural network can include N number of decoder subnetworks 222. However, while the example of FIG. 2 shows the encoder neural network 208 and the decoder neural network 210 including the same number of subnetworks, in some cases the encoder neural network 208 and the decoder neural network 210 include different numbers of subnetworks. The embedding layer 220 is configured to, at each generation time step, for each network output at an output position that precedes the current output position in the output order, map the network output to a numeric representation of the network output in the embedding space. The embedding layer 220 then provides the numeric representations of the network outputs to the first subnetwork 222 in the sequence of decoder subnetworks.

In some implementations, the embedding layer 220 is configured to map each network output to an embedded representation of the network output and combine the embedded representation of the network output with a positional embedding of the output position of the network output in the output order to generate a combined embedded representation of the network output. The combined embedded representation is then used as the numeric representation of the network output. The embedding layer 220 generates the combined embedded representation in the same manner as described above with reference to the embedding layer 212.

Each decoder subnetwork 222 is configured to, at each generation time step, receive a respective decoder subnetwork input for each of the plurality of output positions preceding the corresponding output position and to generate a respective decoder subnetwork output for each of the plurality of output positions preceding the corresponding output position (or equivalently, when the output sequence has been shifted right, each network output at a position up to and including the current output position). In particular, each decoder subnetwork 222 includes two different attention sub-layers: a decoder self-attention sub-layer 228 and an encoder-decoder attention sub-layer 230.

Each decoder self-attention sub-layer 228 is configured to, at each generation time step, receive an input for each output position preceding the corresponding output position and, for each of the particular output positions, apply an attention mechanism over the inputs at the output positions preceding the corresponding position using one or more queries derived from the input at the particular output position to generate an updated representation for the particular output position. That is, the decoder self-attention sub-layer 228 applies an attention mechanism that is masked so that it does not attend over or otherwise process any data that is not at a position preceding the current output position in the output sequence.

Each encoder-decoder attention sub-layer 230, on the other hand, is configured to, at each generation time step, receive an input for each output position preceding the corresponding output position and, for each of the output positions, apply an attention mechanism over the encoded representations at the input positions using one or more queries derived from the input for the output position to generate an updated representation for the output position. Thus, the encoder-decoder attention sub-layer 230 applies attention over encoded representations while the decoder self-attention sub-layer 228 applies attention over inputs at output positions.

In the example of FIG. 2, the decoder self-attention sub-layer 228 is shown as being before the encoder-decoder attention sub-layer in the processing order within the decoder subnetwork 222. In other examples, however, the decoder self-attention sub-layer 228 may be after the encoder-decoder attention sub-layer 230 in the processing order within the decoder subnetwork 222 or different subnetworks may have different processing orders. In some implementations, each decoder subnetwork 222 includes, after the decoder self-attention sub-layer 228, after the encoder-decoder attention sub-layer 230, or after each of the two sub-layers, a residual connection layer that combines the outputs of the attention sub-layer with the inputs to the attention sub-layer to generate a residual output and a layer normalization layer that applies layer normalization to the residual output. These two layers are inserted after each of the two sub-layers, both referred to as an “Add & Norm” operation.

Some or all of the decoder subnetwork 222 also include a position-wise feed-forward layer 232 that is configured to operate in a similar manner as the position-wise feed-forward layer 218 from the encoder 208. In particular, the layer 232 is configured to, at each generation time step: for each output position preceding the corresponding output position: receive an input at the output position, and apply a sequence of transformations to the input at the output position to generate an output for the output position. The inputs received by the position-wise feed-forward layer 232 can be the outputs of the layer normalization layer (following the last attention sub-layer in the subnetwork 222) when the residual and layer normalization layers are included or the outputs of the last attention sub-layer in the subnetwork 222 when the residual and layer normalization layers are not included.

In cases where a decoder subnetwork 222 includes a position-wise feed-forward layer 232, the decoder subnetwork can also include a residual connection layer that combines the outputs of the position-wise feed-forward layer with the inputs to the position-wise feed-forward layer to generate a decoder position-wise residual output and a layer normalization layer that applies layer normalization to the decoder position-wise residual output. These two layers are also collectively referred to as an “Add & Norm” operation. The outputs of this normalization layer can then be used as the outputs of the decoder subnetwork 222.

At each generation time step, the linear layer 224 applies a learned linear transformation to the output of the last decoder subnetwork 222 in order to project the output of the last decoder subnetwork 222 into the appropriate space for processing by the softmax layer 226. The softmax layer 226 then applies a softmax function over the outputs of the linear layer 224 to generate the probability distribution (output probabilities) 234 over the possible network outputs at the generation time step. The decoder neural network 210 can then select a network output from the possible network outputs using the probability distribution.

According to aspects of the technology, one or more encoder neural networks 208 may be employed. Each domain's associated sequences may be embedded in parallel into a twin transformer encoder layer. This means that the encoder components may share weights, enabling for a single embedding transformer to be built across two domains.

### ADPM Explanation

A diversifiable personalization module (ADPM) may be used to personalize downstream models. Examples of downstream models may include Click-Through Rate (CTR) and Post-Click Conversion Rate (PCCVR) models used in rankings for sets of results including sponsored ads, search results, or other types of results or recommendations. CTR models may generate a predicted probability that a particular listing will be clicked, while PCCVR models may generate a predicted conditional probability that a good or service represented by the listing will be purchased. These may be combined into a value score which can be used to sort and determine an order of results in a set of results including sponsored ads or search results. These CTR and PCCVR models may be personalized to individual users using the ADPM. The ADPM may include customizable components such as an encoder component, a pretrained representations component, and a learned representations component as discussed further below.

### Example Methods

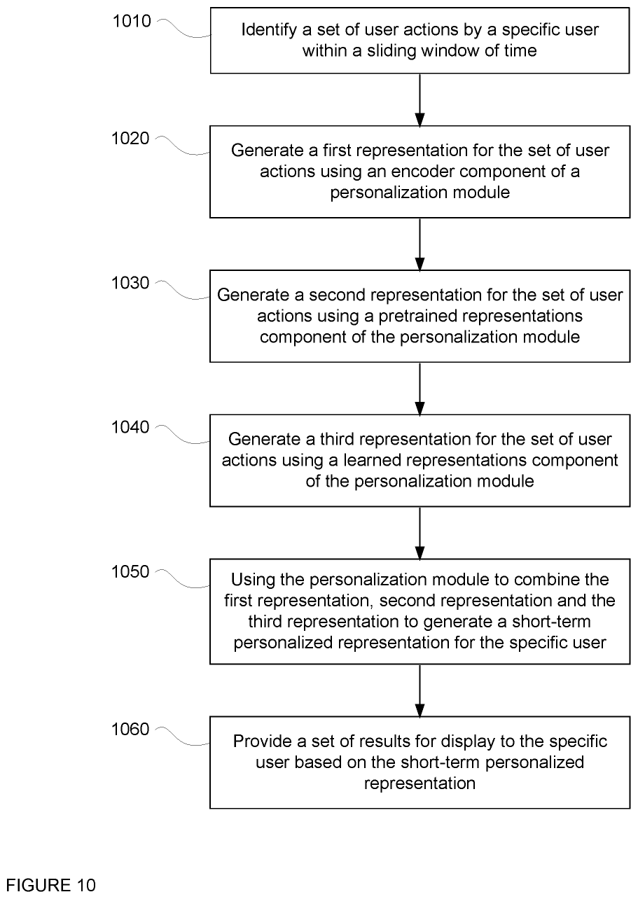

In addition to the operations described above and illustrated in the figures, various operations will now be described. It should be understood that the following operations do not have to be performed in the precise order described below. Rather, various steps can be handled in a different order or simultaneously, and steps may also be added or omitted. FIG. 10 is an example flow diagram 1000 depicting an example method for generating and using personalized models which may be performed by one or more processors, such as one or more processors of the server 102. At block 1010, a set of user actions by a specific user within a sliding window is identified. This set of user actions or user behavior data may be accessed and retrieved from memory, such as memory of the server 102 and/or the storage systems 104, 106, 108.

The ADPM may encode sets or sequences S of recent user actions for the specific user. For instance, the i^{th} sequence may be represented by Sᵢ=(aᵢ,eᵢ) of variable sequence lengths yi, variable entity types eᵢ and variable action types aᵢ. The value e may represent a listing identifier (“listing ID”) or other types of identifiers such as a category or taxonomy identifier (“taxonomyID”) or shop identifier (“shopID”), and a may represent an action of the user behavioral data such as any of view, favorite, cart add, purchase, search, etc. The sequence length y may be a range of values from 0 to M, where M may be a maximum sequence length dictated by the features of the system 110.

The sequence length y may be determined by the number of actions by the specific user captured during a sliding window. The sliding window may be defined in time, for example may be 30 minutes, an hour, 2 hours, or more or less. In this regard, the set may include no user actions, one user action or a plurality of user actions depending on the circumstances of a user's current behavior without relying on an arbitrary number of actions (e.g., the last 4, 5, 10, 20, 100, etc., actions). In many cases the arbitrary number of actions may depend upon typical user actions at an E-commerce website where the user behavioral data was collected (the last 20 actions may have occurred over the course of several months at one E-commerce website or in the last five minutes at another website). In that regard, the sliding-window of time may be better able to capture relevant user actions over a plurality of different types of websites.

The sliding window may be adjusted in some circumstances, for example, based on the current location of the specific user (e.g., GPS location, location via IP address, or some other location) and/or the types of listings the specific user has selected within the sliding window. For example, in some states or countries users may spend more time browsing certain types of goods or services before making a purchase. In other examples, some users may spend more time browsing before making a purchase on higher-cost goods or services versus lower-cost goods or services. In some instances, the number of user actions within the sliding window may be limited in number to some maximum sequence length, such as 50 actions or more or less which may be determined based on semantics, infrastructure constraints, latency requirements or other considerations.

Returning to FIG. 10, as shown in block 1020, a first representation for the set of user actions is generated using an encoder component of a personalization module. For instance, the encoder component may be configured as a transformer encoder which includes a max pooling layer. In this regard, the encoder component may be implemented as an importable Keras layer (such as PyTorch, MXNet, etc.) which encodes short-term sequences of different listings within the aforementioned window into representations. Each listing may be represented by a listing identifier or listing ID. These may be padded and masked to a common length corresponding to the maximum sequence length. The resulting representations may thus encode both the content and position of the sequence of user actions. Using a transformer encoder may capture inter-item (e.g., inter-listing) dependencies while also accounting for the sequence ordering of those listings. Thus, the result may be very expressive representations of the actions by the specific user within the sliding window.

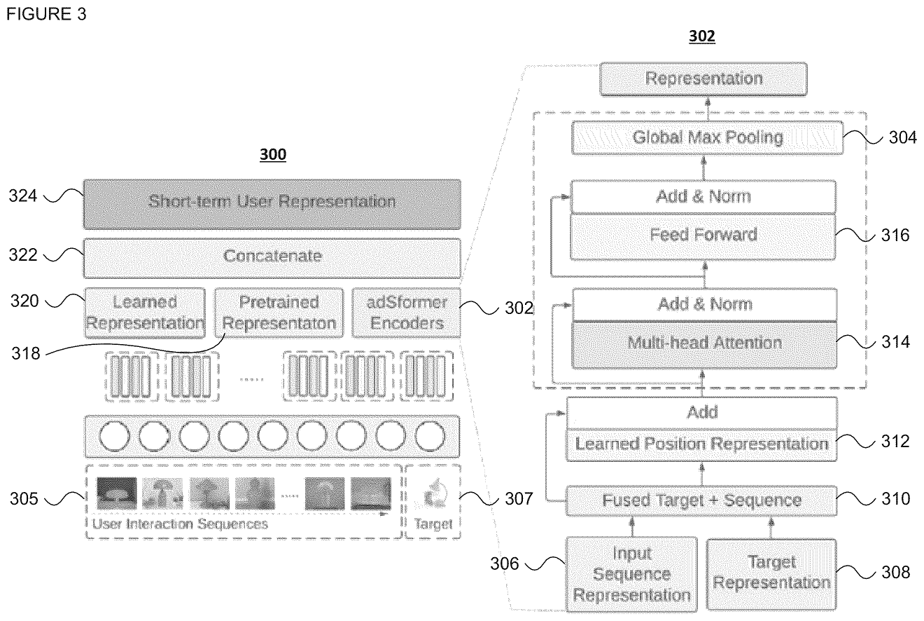

FIG. 3 provides a visual representation 300 of the ADPM. In this example, the encoder component uses a custom adSformer component 302. This component learns a deep, expressive representation of an input sequence. The adSformer component modifies a standard transformer block by adding a final global max pooling layer 304. This layer may down sample the adSformer component 302's outputs by extracting the most salient signals from the input sequence representation 306.

The user interaction sequences 305 may represent a sequence of identifiers of listings that were recently interacted with by a user (e.g., within the sliding window), and the target 307 may represent a current listing ID for which the system is currently attempting to predict a probability.

The adSformer component 302 starts with an embedding layer 312 which encodes listing IDs of the interaction sequence 305 into dense vectors of size d or d₁. As an example, d₁=32. Of course, other values of d₁ may be used, for example ranging from 16 to 128. This number may be selected in consideration of various tradeoffs including memory constraints, speed of training, amount of data needed, and offline model evaluation. In one instance, the value of the vectors as the fourth root of the size of the vocabulary (or K) as discussed further below (e.g., size: d₁=K**0.25 or ⁴√K). The variable length sequence may be padded to a common length of M and mask the padding token in order to generate an input sequence representation 306. The target listing representation 308 may be concatenated at position zero. A fully learnable position embedding of same dimension d₁ may be added to learn the sequence order for the concatenated target representation, or the sequence representation, input sequence 310. A multi-head self-attention layer 314 with scaled dot-product attention may take the input sequence 310 and generate an attenuation representation. The multi-head self-attention layer 314 may utilize the following equation for the attenuation representation:

$$A ( Q , K , V ) - softmax ( \frac{{QK}^{T}}{\sqrt{d}} ) V ,$$

Here, Q, K and V may represent query, keys and value matrices, respectively, which can be used in the calculation of attention for various machine learning applications. In this regard, A is the attention. Then the multi-head self-attention (MHSA) may be represented by:

$$MHSA ( EP ) = Concat ( {head}_{1} , {head}_{2} , … , {head}_{h} ) {W}^{H} ,$$

In this example, headᵢ=A(EW^{Q},EW^{K},EW^{V}). In addition, h refers to the number of attention heads, and W^{H} is a learnable weight matrix applied after concatenating the outputs from all attention heads. The projection matrices may include W^{Q}, W^{k}, W^{v}∈R^{d×d}, and EP may represent listing embeddings (E) added to position embedding (P) or EP=E+P. Then a transformer block 316 adds point-wise feed-forward networks F FN, LeakyRelu non-linearity and residual connections, dropout and layer normalization in a typical or usual sequence.

To simplify notation, s may be the output of transformer block 316, and g(s) may represent the output of the final global max pooling layer 304. In this example:

$$\begin{matrix}g ( s ) = s + Dropout ( MHSA ( s ) ) , \\ s = LayerNorm ( s + g ( s ) ) , \\ g ( s ) = Dropout ( FFN ( LeakyRelu ( s ) ) , \\ s = LayerNorm ( s + g ( s ) ) .\end{matrix}$$

The final global max pooling layer 304 may be added at the last stage as a vector o₁=GlobalAveragePooling(s). In this example, o₂ therefore represents the output of the adSformer component 302. The final global max pooling layer 304 may down sample the output of the transformer block 316 to a representation vector of the size d₁ instead of outputting the concatenated transformer block features for the entire sequence. Thus, the most salient signal may be retained, in a parameter efficient manner. As discussed further below, the global max pooling layer 304 may be replaced with a global average pooling layer.

Returning to FIG. 10, as shown in block 1030, a second representation for the set of user actions is generated using a pretrained representations component of the personalization module. As shown in FIG. 3, a pretrained representations component 318 may be configured to encode sequences of user actions within the aforementioned window to generate additional pretrained representations. These pretrained representations may encode diverse features such as image, price, color, category, semantic text. Other pretrained representations may also be used for different use cases. For instance, sequences of recent search queries may be concatenated and encoded using fine-tuned text representations such as Skip-gram text representations. Sequences of listing IDs may be encoded as multimodal representations using pretrained multimodal (AIR) representations, as visual representations, and/or as interaction-based representations such as Skip-gram listing representations. Such pretrained representations may be useful for feature encoding, scalability and modularity. The pretrained representations component may be key for configurability and scalability of the ADPM.

The pretrained representations component 318 may encode sequences using listing ID pretrained representations together with average pooling. Depending on downstream performance and availability, one or more of multimodal (AIR) representations detailed, visual representations, or interaction-based representations may be used. Thus the pretrained representations component 318 may encode rich image, text, and multimodal signals from all the listings in the variable length sequence as a sequence representation of a vector o₂. For instance, for a given sequence of listing IDs' embedding vectors eᵢ∈R^{d}^{₂}, the value of o₂ may be computed as o₂=GlobalAveragePooling([e₁,e₂, . . . ,e_{y}]). Again, the sequence length y may be a range of values from 0 to M where M may be a maximum sequence length dictated by the features of the system 110. Then the output of pretrained representations component 318 or o₂ is a sequence representation vector of size d₂. As an example, d₂=256. Of course, other values of d₂ may be used, depending upon the specifics of the desired representations. For example, different values may be used for different types of representations: visual representations may be vectors of dimension size 256, AIR representations may be vectors of dimension size 128, and Skip-gram representations may be vectors of dimension size 64. This number may be selected in consideration of various tradeoffs including memory constraints, speed of training, amount of data needed, and offline model evaluation. For example, larger representations may encode more information, but may also require more memory, compute, and disk space than smaller representations. Each individual listing ID's pretrained representations may be kept frozen in downstream tasks, not requiring an expensive gradient calculation, while adding multimodal signals.

The pretrained representations component 318 of the ADPM may employ pretrained representations to encode variable-length sequences of user actions. Various pretrained representation learning workflows may be used where various representations may be trained and used to encode listing IDs including visual, multimodal (AIR), and Skip-gram as noted above.

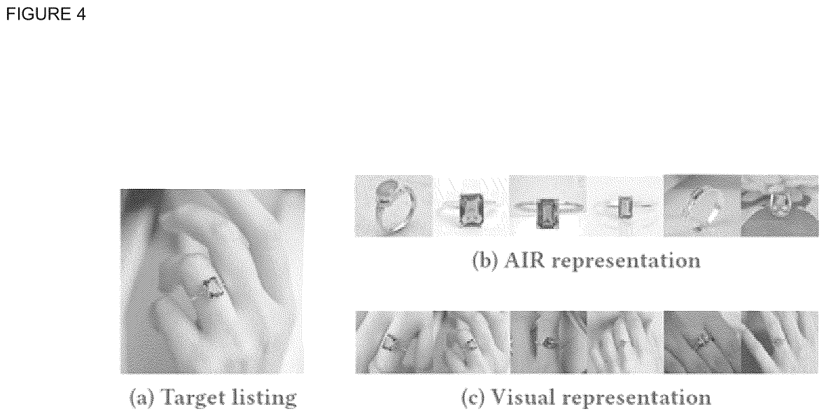

The pretrained representations component 318 may depend on the specifics of the downstream tasks, as explained in ablation studies below. For example, as depicted in FIG. 4, for a target listing (a) of a ring, the top k nearest neighbors (only 5 being shown for simplicity) are different when using visual representations in (c) and AIR representations in (b). In this regard, AIR representations may better encode price, category, and text while the visual representations better encode color, shape, and background image.

A visual representations model of the pretrained representations component 318 may be trained using a multitask classification architecture or alternatively classification as a proxy to metric learning. By using multiple classification heads, such as taxonomy, color, and material, the pretrained representations may be able to capture more diverse information about the image. An EfficientNetB0 architecture with weights pretrained on ImageNet may be used with a final layer replaced with a dimensional convolutional block of size d₂ (e.g., 256) or the desired output representation size. Image random rotation, translation, zoom, and a color contrast transformation may be used to augment the dataset during training.

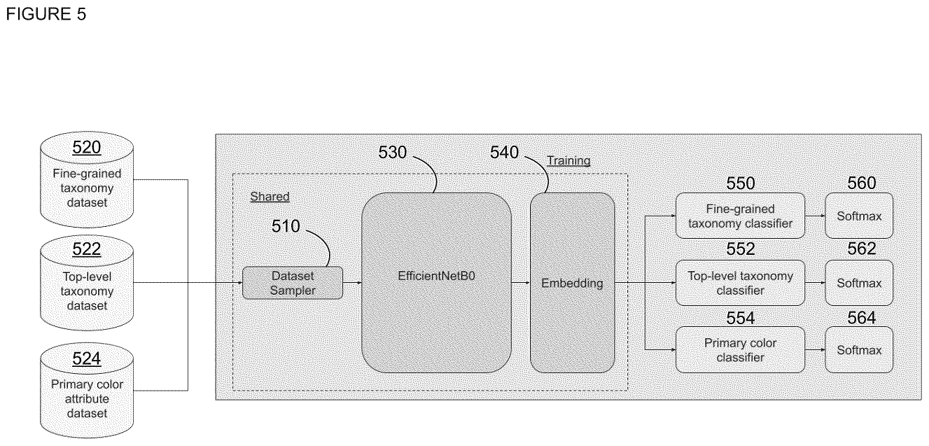

Rather than using a single dataset of listing images with multiple label columns, heterogeneous dataset sources containing product images with different selected attributes as the labels were included. Listing attributes such as color and material may be optionally input by sellers, so they can be sparse. To address this a dataset sampler 510, represented in FIG. 5 may be used. In this example, the dataset sampler may take in the separate datasets 520, 522, 524, each with its own unique label type. Each of these datasets may include instances containing pixel values for an image with a label related to that image. In addition, each of these datasets can be treated disparately. In that regard, if an image is missing one of the labels from one of the datasets, the image need not appear in that dataset.

For instance, dataset 520 may represent the fine-grained taxonomy for the image or the likelihood (e.g., 0, 1 or a range from 0 to 1, where 1 is very likely and 0 is not at all) that the image belongs to each of a plurality of fine-grained categories. The number of categories may be relatively large, such as 1000 or more or less. Examples of fine-grained taxonomies may include, “shoes.mens_shoes.boots.work_boots”, “jewelry.rings.wedding.bands”, or “home_and_living.bedding_blankets.throws.throws”.

Dataset 522 may represent a top-level taxonomy for the image or the likelihood (e.g., 0, 1 or a range from 0 to 1, where 1 is very likely and 0 is not at all) that the image belongs to each of a plurality of top-level categories. The number of categories may be relatively small, such as 10 or more or less. Examples of top-level taxonomies may include, “jewelry”, “art”, “clothing”, “electronics”, “home and living”, etc.

Dataset 524 may represent a primary color of an image or a likelihood (e g., 0, 1 or a range from 0 to 1, where 1 is very likely and 0 is not at all) that each image belongs to a particular color classification. The number of categories may be relatively small, such as 40 or more or less. Examples of color classifications may include “red”, “yellow”, “turquoise”, “forest green”, “light pink”, “off-white”, etc.

As an example, a listing for an off-white wool blanket may be identified as being in “home_and_living.bedding_blankets.throws.throws” for dataset 520, being in “home and living” for dataset 522, and being in “off-white” for dataset 524.

The sampler may evenly distribute examples from each dataset to construct balanced training batches and ascertain that only loss coming from the respective task's classification head is considered during back-propagation. In this regard, the sampler may ensure that each training batch contains an even mix from each dataset. This may enable a mixing of datasets of images from different visual domains to support more use cases, such as user-uploaded review photos. The visual representations may be integrated into the visually similar ad recommendations and search by image applications as discussed further below.

The output of the sampler 510 may be input into a convolutional neural network (CNN) 530 functioning as a “backbone”. In this example, the CNN 530 may include the EfficientNetB0 network (referred to here as the “EfficientNetB0 backbone”) developed by GOOGLE INC, or any other CNN includes multiple convolutional layers and can be used to process two-dimensional (2D) inputs such as images. EfficientNet includes a family of CNNs pre-trained on a category classification over the ImageNet dataset, an open source dataset of images divided into thousands of semantic categories (e.g., “dog”, “table”, etc.). EfficientNetB0 is the smallest available in this family.

When using the CNN 530, a transfer learning approach involving a “freeze” of the first N number of layers and a “fine-tune” of only the final 75 layers may be used. As such, during training, the pre-trained weights for those frozen layers may be maintained (e.g., not updated), and only the weights for the final layers are updated with a small learning rate. This approach may be particularly beneficial as early layers in an image processing neural network are known to capture low level information such as contour detection and shape recognition, which can be shared across different tasks, and the last layers are known to capture higher level concepts.

The output of the CNN 530 may then be input into an embedding block 540. The embedding block may include a single dense layer with the desired output dimension. This embedding block may also be fine-tuned as part of training, followed by L2 normalization.

Finally, output of the embedding block may be input into various classification heads (e.g., classifiers 550, 552, 554). Each input dataset (e.g., datasets 520, 522, 524) may be associated with a corresponding classifier. Each classifier may include dense layers with dimensions matching the number of distinct labels in the dataset corresponding to the classifier. So for example, for a fine-grained taxonomy dataset with 1000 distinct classes, the corresponding classifier will have a dimension of 1000. The output of the classifiers may then be processed using a corresponding softmax/categorical cross entropy loss computation 560, 562, 564. The loss may be computed as discussed further below.

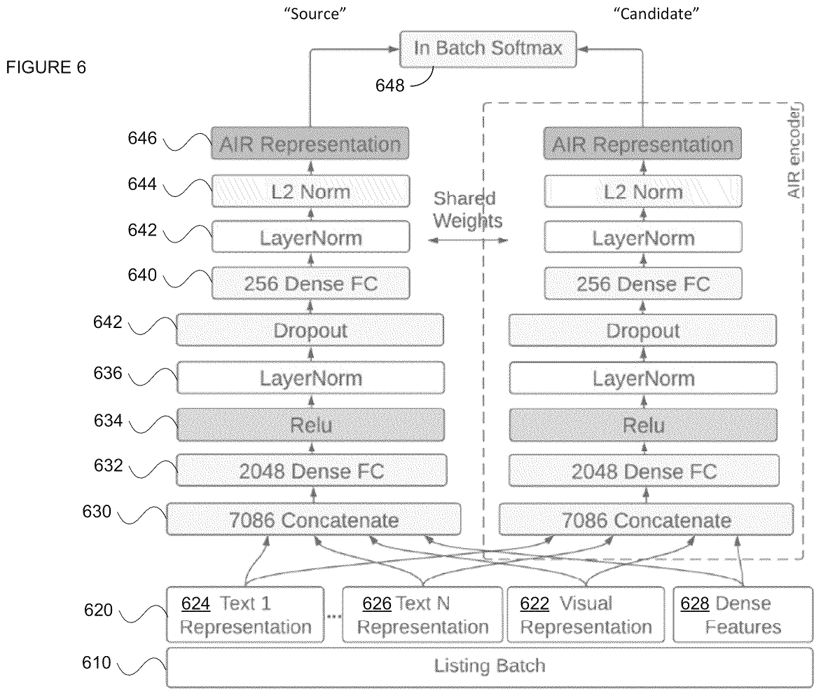

An Ads Information Retrieval (AIR) pretrained listing representations model of the pretrained representations component 318 may be designed to drive ad clicks. The AIR pretrained listing representations model may be a neural network with a tower architecture represented in the example of FIG. 6. The AIR pretrained listing representations model may be trained with a softmax loss and a classification objective. The resulting AIR representations 646 are later used for nearest neighbor candidate retrieval and in the case of ADPM used as one of the pre-trained representations used within the module.

While FIG. 6 has been represented as two “towers”, one for processing a “source” listing and another for processing a “candidate” listing, these are really the same tower as both towers share the same weights. The two different listings (source and candidate, discussed further below) may thus pass through the same tower, and the model objective is to compare the outputs against one another and update the weights for the model such that the source and candidate listings are closer together if similar. For instance, A dataset of listing pairs that have been clicked together on various pages may be compiled as listing batch 610. As noted above, for each pair, one listing may be considered as the “source” and the other listing as the “candidate” within the same example. The training dataset may thus include source-candidate pairs, where for each source its corresponding candidate pair may be considered as positive examples or labels while a sample of the other examples in the same batch may be considered as negative examples labels for training purposes.

For each of the source and candidate listings, a plurality of multimodal features may be preprocessed and concatenated at block 630 into an input layer 620 as a set of multimodal features. For example, visual representations 622, text representations 624, 626 of listing's title, tags and taxonomy path average pooled from lightweight fastText pretrained representations, and a series of other normalized features 628 may be appended to each other (e.g., tacked onto one another) resulting in the dense feature set 632. For instance if a visual representation is [0.1, 0.3], and a text representation is [0.2, 0.4, 0.6], the concatenation may involve appending one to the other: [0.1, 0.3, 0.2, 0.4, 0.6].

A “rectified linear unit” or Relu layer 634 may function as an “activation” layer. This may be used to introduce the property of nonlinearity to model training and address vanishing gradients issues. Vanishing gradients may occur during backpropagation when values of a gradient are too small and the model stops learning or takes way too long as a result. Thus, the Relu layer 634 may apply a calculation that outputs the input value provided if the input is positive, or the value 0 if the input is 0 or negative. With the Relu layer, the value of the partial derivative of the loss function may have values of 0 or 1 which may prevent the gradient from vanishing.

Thereafter the dense feature set may be normalized at a normalization layer 636. As an example, most numerical features can be normalized using the z-score: z-score=(r−μ)/σ. Where r is the price in cents, μ is the mean of all listing prices and σ is the standard deviation. This may make the model more stable during training by reducing the internal covariate shift. For instance, the normalization layer 636 may normalize the inputs of each layer, making the optimization process more stable. This may also result in the normalization of inputs to that layer across the feature dimension, independently for each example.

The AIR pretrained listing representations model may also include a Dropout layer 642. The Dropout layer 642 may implement a regularization technique used in neural networks which involves randomly “dropping out” (i.e., setting to zero) a fraction of the neurons in a layer during each forward and backward pass of training. This may prevent correlated behavior between neurons and helps to prevent model overfitting in some cases.

During training, source and candidate 256-dimensional representations (vectors) for each pair in the batch may be inferenced at block 640. A further normalization layer 642 may again normalize the inputs as discussed above with regard to the normalization layer 636. Thereafter, an L2 Norm layer 644 may be used to transform the vectors such that each vector's L2 norm (also known as Euclidean distance) becomes equal to 1. This process may involve scaling each vector while preserving direction. This may ensure that the vectors have a consistent scale and to make them more invariant to changes in scale.

A matrix of cosine similarity scores between each example's source and candidate representations may be computed. Finally, the classification loss may be computed using these scores. For instance, In Batch Softmax layer 648 may be used to determine the classification loss in the model, here a cross entropy loss. A set of real numbers called logits may be generated by taking two batches of AIR representations (vectors) from the source and candidate listings to be compared, and computing the distance matrix between each pair of representations. Again, Softmax is an activation function used in deep learning that converts a vector of G real numbers into a probability distribution of G possible outcomes. Softmax may be applied to the classification logits to turn these into probabilities and to select the candidate with the highest probability as the prediction. While the true goal is to classify a source representation with its pair candidate representation out of the full catalog of candidates B, for efficiency reasons, the model need only consider candidates within a given batch as an approximation of the full classification.

The visual, Skip-gram and AIR representations generated using such models may not capture signals from the sequential browsing behavior of users within a web session. To address this a listing representation may be learned from sequences of listings in a browsing session by employing the Skip-gram model. A vector representation of dimension d=64 may be learned for each listing in the training set using a hierarchical softmax loss function. This may provide better results than classic negative sampling. In some instances, the fastText library may be used during training while disabling functionality to consider subwords.

Returning to FIG. 10, as shown in block 1040, a third representation for the set of user actions is generated using a learned representations component of the personalization module. As shown in the example of FIG. 3, a learned representations component 320 may be configured to generate representations learned for a sequence of user actions within the aforementioned window in its own vector space. These representations may embed short-term sequences in the space for the given task in which the representations are used. Two example tasks may include clicks (CTR) and purchase predictions (PCCVR). For such tasks, the learned representations component may embed the sequence of listing IDs from the sliding window in the space of click and purchase probability. The learned representations component may be implemented as a look-up table such as a Keras look-up table.

The learned representations component 320 may generate representations learned for each sequence in vector space as part of the downstream models. For example, learned representations component 320 may learn light weight representations for many different (e, a) sequences. For example, sequences of entities e of various types (e.g., listingID, taxonomyID, shopID, etc.) may be learned for user actions a. For a sequence Sᵢ=(aᵢ,eᵢ) of variable lengths yᵢ, variable entity types eᵢ, and variable action types aᵢ, each entity ei may be embedded in the action space aᵢ to get a vector representation Eₐₑᵢ∈R^{d}^{ₐₑ} of dimensions dₐₑ may be determined by:

$$ESi = GlobalAveragePooling ( [ {e}_{1} , {e}_{2} , … , {e}_{{y}_{i}} ] ) ,$$

$${o}_{3} = Concat ( [ {E}_{{S}_{1}} , {E}_{{S}_{2}} , … , {E}_{{S}_{z}} ] ) .$$

In this example, i∈{1, . . . ,z} and z may be the number of sequences encoded by learned representations component 320. In addition, the vector o₃ represents the output of the learned representations component 320.

Returning to FIG. 10, as shown in block 1050, the personalization module is used to combine the first representation, second representation and the third representation to generate a short-term personalized representation for the specific user. As shown in of FIG. 3, an ADPM concatenation layer 322 may combine the outputs of the various components ([o₁, o₂, o₃]) in order to generate a short-term personalized representation u for the specific user. This personalized representation may be considered a short term dynamic user representation. For instance, given an input set of p user action sequences Sᵢ=(aᵢ,eᵢ), i∈{1, . . . ,p}, of variable lengths yᵢ, the ADPM layer concatenation layer 322 concatenates the outputs of the three components (o₁ of the adSformer component 302, o₂ of the pretrained representations component 318, and o₃ of the learned representations component 320), to derive short-term personalized representation u (represented by layer 324 of FIG. 3) of size d₁+d₂+dₐₑ:

$$u = ADPM ( {S}_{1} , {S}_{2} , … , {S}_{p} ) = C o n c a t ( [ {o}_{1} , {o}_{2} , {o}_{3} ] ) .$$

This short-term personalized representation u may then be further concatenated to an input layer in further downstream personalization tasks.

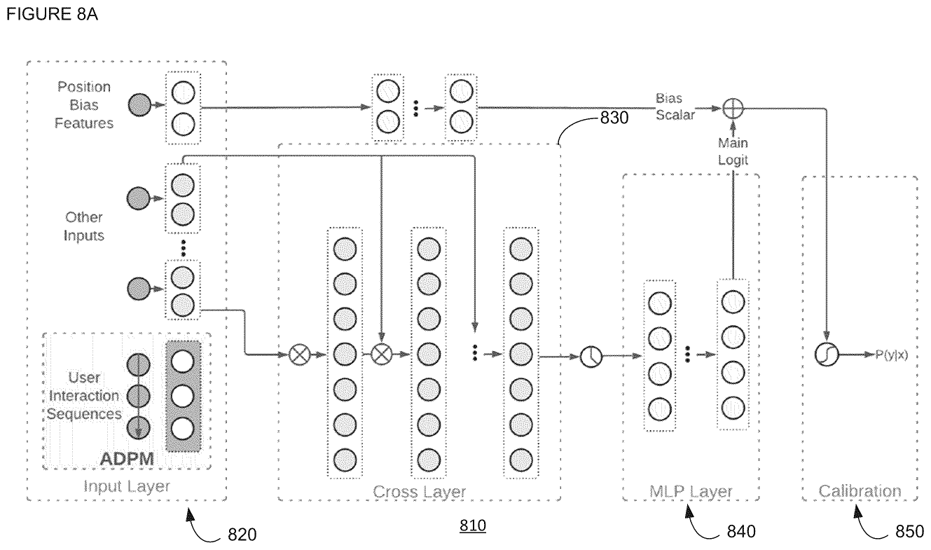

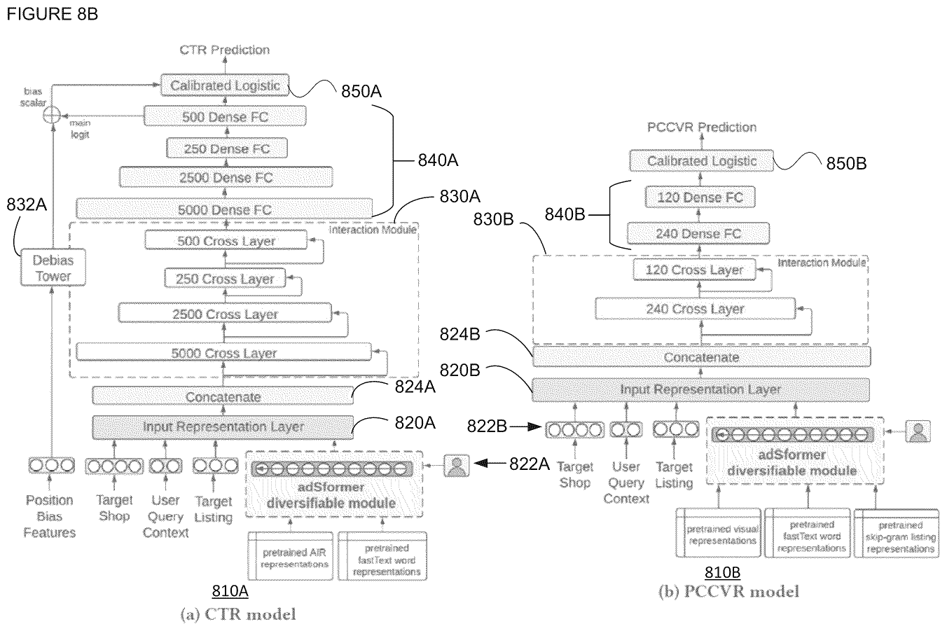

The ADPM may be configured as a general plug-and-play module and implemented as a TensorFlow Keras layer which can be reused across personalization use-cases with a simple import statement (represented in FIGS. 8A and 8B). The ADPM concatenation layer 322 may also be configurable, allowing arguments for customizing the aforementioned three components. Since sequences of streamed user actions may be made available to downstream applications, the short-term personalized representations can be easily scaled to multiple downstream personalization tasks while at the same time introducing a per-model customization to avoid sacrificing performance.

In order to facilitate this, periodically (e.g., daily, weekly or nightly), representations of all active listings may be automatically generated in an offline process. Running this process offline may allow for deeper architectures without latency concerns. These representations may be represented by output vectors which may be joined to downstream models (e.g., CTR and PCCVR models), now personalized downstream models (e.g., personalized CTR and personalized PCCVR models as discussed further below), by way of a look-up table and a mapping between vocabulary and index positions.

However, in some instances, the number of listings may be significantly large, for example, on the order of 100 million (mln) or more or less. In such instances, rather than generating representations for all active listings, the “vocabulary” used for the pretrained representations component may be culled down to a number (e.g., K above) appropriate for the computer systems processing the listings as well as generating and storing the representations. For instance, the number of listings for which representations are periodically generated may be reduced to the top K most frequently viewed, clicked or otherwise accessed. In this regard, the value of K is effectively tuned as a hyperparameter of the personalized downstream models. For example, using the 100 million listing total, K may be set to 750 thousand or more or less. At some point, the number of additional listings included in K will lead to only marginal improvements in model performance thus, there is a tradeoff between the value of K and the processing and memory requirements needed to periodically generate the aforementioned representations. In addition, the lookup table may be wrapped in a TensorFlow SavedModel which includes average pooling layers and handling of default padding values. In other words, by saving the look-up table with the personalized downstream models, this may ensure that the representations used for training and the ones used when serving results to users.

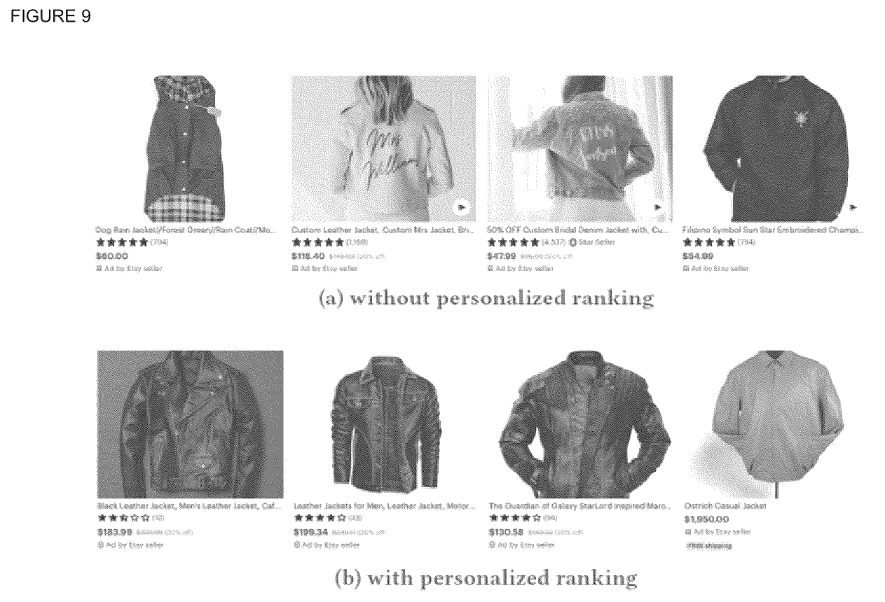

Returning to FIG. 10, as shown in block 1060, a set of results is provided for display to the specific user based on the short-term personalized representation. FIG. 9 provides an example of ads displayed to a particular user in response to a query using the term “jacket”. The top example (a) utilized a non-personalized ranking, while the bottom example (b) utilized a personalized ranking for the user that entered the query in accordance with the features discussed further below. In this example, the particular user had recently interacted with men's leather jackets. As such, the personalized ranking results using ADMP (both personalized CTR and PCCVR) include men's leather jackets while the non-personalized ranking results are less specific to men's leather jackets.

FIGS. 8A and 8B are examples of different models that can be personalized using ADPM. FIG. 8A represents a generic model, and FIG. 8B represents specific models for each of CTR and PCCVR. Although the features discussed herein focus particularly on CTR and PCCVR, the ADPM features described herein may be configurable for different tasks. For example, with the ADPM, hyperparameters, including learned embedding size, number of attention heads, pretrained representation model, sequence length, etc. may be tuned based on the task at hand. Thus, ADPM may be used to personalize any generic modeling task (represented by the model of FIG. 8A) where an input sequence of interaction IDs is available: click fraud, spell correction, auto-suggest, movie recommendations, etc.

In order to provide this set of results, the short-term personalized representation u may be used to personalize (e.g., train) the CTR and PCCVR models for the specific user (hereafter “personalized CTR” and “personalized PCCVR”). Both models may share a similar architecture with slight differences in numbers of layers and hidden units as depicted in the example model architectures model architecture of the personalized CTR and personalized PCCVR of FIGS. 8A (generic model) and 8B (specific for each of CTR and PCCVR).

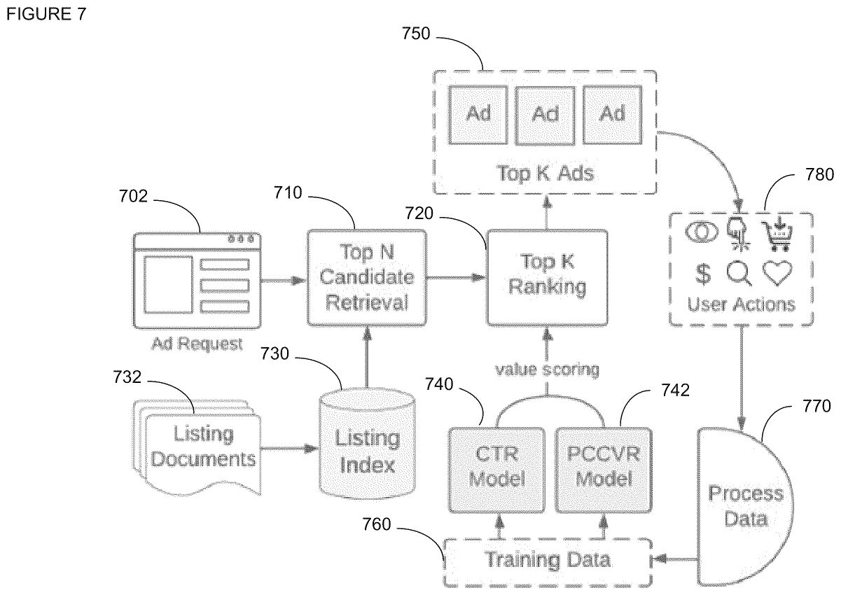

For instance, many online platforms may allow sellers to sponsor listings (e.g., ads) through a second-price cost-per-click auction campaign. In order to decide which ads to display to a user via a computing device (such as computing devices 112, 114), a Learning to Rank (LTR) framework may be used as depicted in FIG. 7. In this example, the LTR framework is divided according to a two-stage process: ads candidate retrieval 710 and ads ranking 720. The listing documents 732 may include all of the information for each listing such as listing IDs, titles, tags, descriptions, categories, attributes, prices, etc., for all of the listings in the system. When a user's actions (e.g., using computing device 112, 114 to click on a link on a web page) result in request for an ad (e.g., Ad Request 702) or a request (e.g., a web service call) to the server 102 to provide an ad, this may trigger the ads candidate retrieval 710 to winnow the listing index 730 from the listing documents 732 from a large number (e.g., over 100 million listings) to a much more manageable number (e.g., “Top N Candidate Retrieval” is equal to or less than 1000 candidates). Thereafter, results may be re-ranked based on a combined value score output by the personalized CTR and PCCVR models 740, 742 respectively in order to output the top K advertisements 750. One or more of these top K advertisements 750 may then be provided by the server 102 to another computing device (such as the computing devices 112, 114 that sent the original Ad Request 702) for display to the user. As noted earlier, the personalized CTR and PCCVR models may be trained using training data 760 including processed data 770 generated as described above from sequences of user actions 780 as well as the various representations.

In the CTR case, p(x) denotes the predicted probability p(y_{CTR}=1) that a candidate listing (represented by x, a vector of input features or attributes) will be clicked. For PCCVR p(x) denotes the predicted conditional probability p(y_{PCCVR}=1 y_{CTR}=1) that the candidate listing (represented by x, a vector of input features or attributes), having been clicked, will also be purchased. Referring to FIGS. 8A-8B, before including the ADPM (e.g., before personalization), the non-personalized generic, CTR and PCCVR baseline model architectures 810, 810A, 810B may include a cross layer referred to as an interaction layer or interaction module 830, 830A, 830B which may include standard stacked deep and cross neural networks (DCN).

When two or more features are combined, such as listing color and listing material, into all the permutations of color material, this may be considered a feature cross. Historically, this has been performed manually by hand selecting the best features that cross together. However, this can be replaced with a model architecture or cross layer that learns all feature interactions. Such layers may form the foundations of a “deep and cross network” architecture which learns polynomial bounded degree feature interactions. In this regard, CTR's interaction module 830A may have four cross and four deep layers with sizes 5000, 2500, 250, 500 and PCCVR's interaction module 830B may have two cross and two deep layers of sizes 240 and 120 respectively as represented in FIG. 8B. The cross layers in these examples may depict the number of dense units (e.g., 250, 500, 2500, 5000) in a cross layer which applies feature crossing against itself and previous layers. The highest polynomial degree function that can be learned may also increase with layer depth: degree 4 in the case of CTR and 2 in the case of PCCVR. The deep layers (e.g., Dense FC) layers may depict the number of dense units (e.g., 250, 500, 2500, 500) in one hidden layer of a feedforward multilayer perceptron. For example, 250 Dense FC and 500 Dense FC may represent 250 and 500 feed forward fully connected dense units, respectively. Similarly, 2500 Dense FC and 5000 Dense FC, may represent 2500 and 5000 dense fully connected neural network layers, respectively. Of course, the number of units and layers used may be chosen through hyperparameter tuning and limits on memory and request latency.

The personalized CTR and PCCVR models trained using the ADPM described herein may result in improved user outcomes. In some instances, the ADPM may be used to encode sequences of recent user actions anywhere for users who are logged-in to an E-commerce website as well as for users who are logged-out of that E-commerce website. Again, instead of considering the last fixed number of user actions, a sliding window of user actions may be used, in reverse chronological order of timestamps, to encode only recent behavior. As noted above, the set of user actions S=a, e, t, be a one-hour sequence of user actions, where a is the action type one of {view, favorite, cart add, purchase, search }, and e represents one of the entities {listingID, shopID, categoryID, text query} associated with action a performed at timestamp t. Due to semantics and infrastructure constraints a maximum sequence length, such as M=50 actions, may also be used. Each sequence I may also be truncated to within one hour of the most recent action, so t₀−tₗₐₛₜ≤1 hour. The resulting sequences may have variable length which the ADPM can handle through padding and masking.

ADPM's output, the dynamic user representation u, may be concatenated to the features input into the downstream model(s). For example, as shown in FIGS. 8A-B, an input layer 820, 820A, 820B may take in various input features including input features 822A, 822B as well as those depicted within input layer 820, including the output of the ADPM. These may be concatenated together prior to being input into the interaction layer 830, 830A, 830B. These input features may vary depending upon the model. For example, as shown in FIG. 8B, for the CTR model, the input features 822A which are taken in at the input layer 820A and concatenated at the concatenation block 824A, may include the output of the ADPM (here based on pretrained AIR representations and text representations), as well as other input features such as position bias features, target (e.g., target shop), context of the user request (e.g., user query), and target listing (which ad the user has selected). For the PCCVR model, the input features 822B which are taken in at the input layer 820B and concatenated at the concatenation block 824B may include the output of the ADPM (here based on pretrained visual representations, text representations, and Skip-gram representations) as well as other input features such as target (e.g., target shop), context of the user request (e.g., user query), and target listing (which ad the user has selected).

Each of the models of FIGS. 8A-8B may also include a “Multi-Layer Perceptron” (MLP) layer 840, 840A, 840B. The MLP layer may include a feedforward neural network where information flows through the network in one direction—from the input layer through one or more hidden layers to the output layer—without forming cycles or loops.

In addition, each of the models may include a calibration layer 850, 850A, 850B. This layer may convert model “logits” which have unbounded range to “probability” values which range from 0 to 1. The calibration layer may be learned separately using a Platt scaling (or Platt calibration).

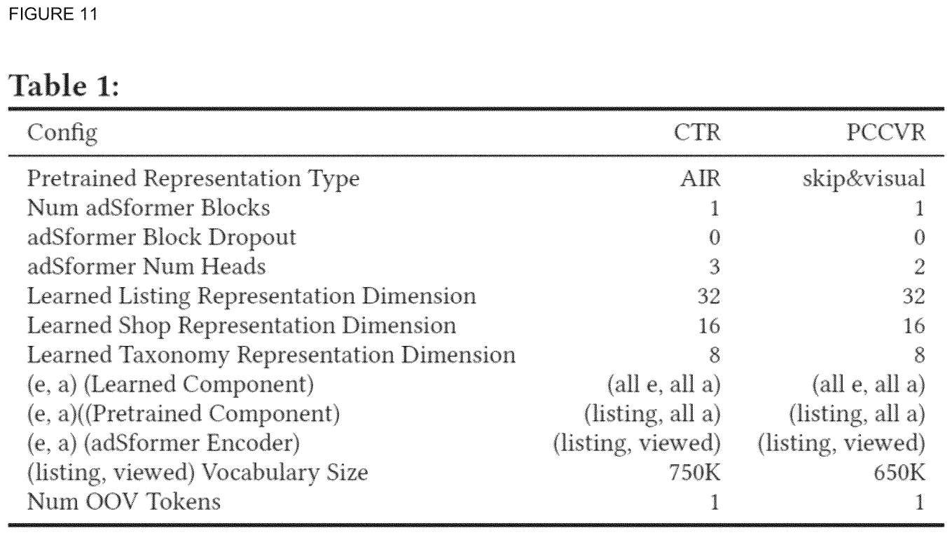

The optimum ADPM configuration for the three components may differ between the personalized CTR and the PCCVR models as Table 1 of FIG. 11 details. This flexibility is another of ADPM's benefits. Each configuration choice is similar to a hyperparameter that can be tuned.

To obtain the personalized CTR model, the ADPM may be used to train the non-personalized CTR baseline model. For the personalized CTR model, the adSformer component 302 includes one adSformer block with three attention heads. The adSformer component 302 may encode user and browser sequences of recently viewed listings since these e, a have the highest session frequency. Within the pretrained representations component, the multimodal pretrained representation (AIR) described above may be most useful for the CTR model to encode all sequences of listing IDs.

After concatenating the ADPM's output to the input representation layer at the concatenation block 824A, 824B, interaction module 820A, 820B is included in the personalized CTR and PCCVR architectures. Learning higher order feature interactions effectively from the input layer may help performance in large scale CTR prediction. For the personalized CTR model, the interaction module may enable the leveraging of the wide input representation which includes the ADPM. The cross layer exclusion may lead to a 1.17% drop in “Area Under the Curve” (AUC) of the “Receiver Operating Characteristic” curve (ROC) (e.g., ROC AUC). The large capacity of the personalized CTR model may aid learning and generalization by providing a smoother loss landscape and more stable and faster learning dynamics. The personalized CTR may only require one epoch of training, for a total of 11 hours (one A100 GPU) using an Adam optimizer. Throughout model training, the learning rate may be decayed using cosine annealing. The largest batch size that can fit in memory (8192) may be used, and the learning rate may be tuned to an optimum learning rate of lr=0.002.

To obtain the personalized PCCVR model, the ADPM may be used to train the non-personalized PCCVR baseline model. In this regard, the ADPM may be configured to concatenate its output user representation to the PCCVR baseline model input layer, similarly to the CTR. Table 1 of FIG. 11 also provides the ADPM configuration for the personalized PCCVR model. The major differences to the CTR's case may be a smaller optimum adSformer component 302 with only two heads. The non-personalized PCCVR baseline model may also be trained on smaller datasets. The ADPM's pretrained representations component 318 may be trained with the pretrained Skip-gram and visual listing representations. The non-personalized PCCVR baseline model may be trained on a longer timer period (e.g., two weeks of historical click logs corresponding to approximately 135 million examples), but may be even more effective when trained on longer periods of time (e.g., three weeks of historical click logs corresponding to approximately 200 million examples.

Both the CTR and PCCVR baseline and personalized models may be formulated as binary classification problems and thus, a binary cross entropy loss function L may be used:

$$L = - \frac{1}{G} {\sum }_{( x , y ) ∈ D} ( y log p ( x ) + ( 1 - y ) log ( 1 - p ( x ) ) ) .$$

In this example, D may represent all samples in the training dataset, y∈{0,1} is the label, p(x) is the predicted probability as noted above, G represents the total number of examples in the training dataset, and, as noted above, x is a vector of input features 832A, 832B including the short-term personalized representation u.

ADPM's effectiveness may be through offline and online experiments by comparing the personalized CTR and PCCVR models to the non-personalized CTR or PCCVR baseline models described above. In addition, ablation studies which compare the ADPM with other user sequence modeling approaches may be used. Further, the effectiveness of permutations of ADPM configurations may also be compared in offline experiments. Offline performance may be evaluated using area under the precision recall curve (e.g., PR AUC) and ROC AUC metrics and present lifts as compared to various baseline models in the ablation studies.

Each of the three component may learn different signals and together through this diversity lead to better outcomes in downstream tasks. For a comparison, the configuration of the ADPM may be permutated while holding constant all other modeling choices and provide lifts in the CTR and PCCVR area under the curve (e.g., AUC) metrics. In addition the ADPM may be compared to a baseline encoder of user sequences, such as Alibaba's Behavior Sequence Transformer (BST), which may use an eight head transformer encoder with one block to encode a sequence of 20 user actions and their timestamp. As another example, the ADPM may be compared against a simple average embedding aggregation of the last five user actions. The goal is to understand if the ADPM is more effective through its design choices then these baselines when used to personalize a downstream task, such as the CTR model. To make these comparisons as relevant as possible, the same underlying sequence lengths and datasets, training budgets, as well as hyperparameters may be used, though some differences will remain dictated by differing implementation pipelines between ADPM and the baselines. For example, the BST may require learning position embeddings rather than timestamp deltas as in ADPM. However, when employed to personalize the CTR model in ADPM's place, the BST may run out of memory for a one hour sequence and eight heads at an embedding size of 32 and for the same batch size employed in all experiments, so BST may be downsized to five and three heads.

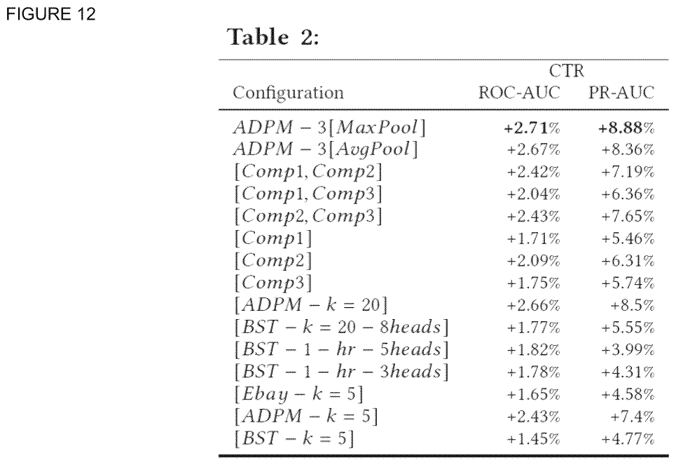

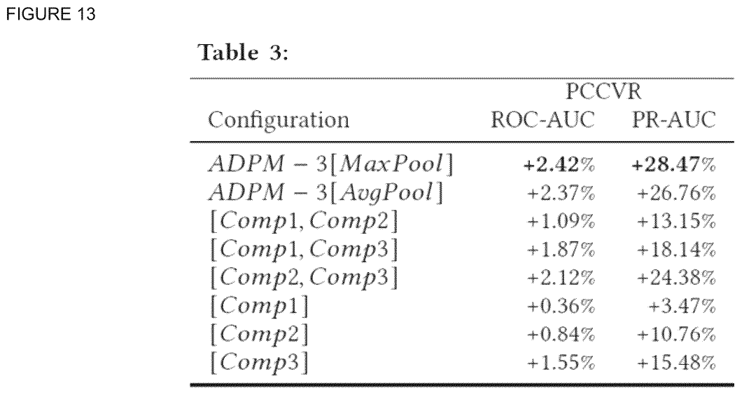

Another benefit of ADPM is the ability to derive maximum signal with constraints on training and serving resources. As noted above, ADPM may also be compared against a simple average embedding aggregation of the last five user actions (e.g., k=5 user actions) as provided in Table 2 of FIG. 12, as well as against BST run on a fixed sequence length of the 20 most recent user actions as provided in Table 3 of FIG. 13. To summarize the results in Tables 2 and 3, ADPM outperforms all the other component combinations as well as the BST and other baselines.

An average pooling layer may replace the final global max pooling layer in the adSformer component 302. Results may be similar for each, as the average is influenced by extreme values in a sample such as the max. The global max pooling may still be more effective in deriving a different signal from the sequence which complements the signals derived by the pretrained representations component 318 and the learned representations component 320. ADPM may also outperform when encoding the last five or the last 20 user actions instead of a one-hour, variable-length, sequence.

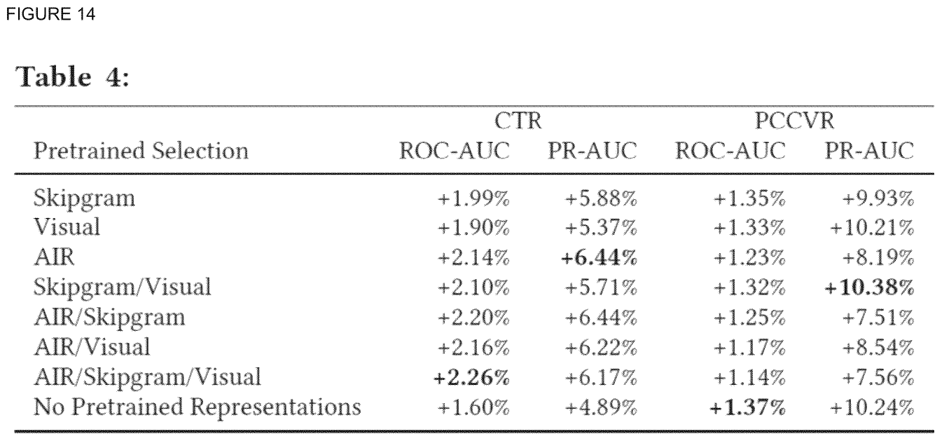

Table 4 of FIG. 14 illustrates how different configurations of the pretrained representations component 318 lead to different ROC AUC and PR AUC results. Combining all three types of pretrained representations in the personalized CTR may lead to the highest test ROC AUC. However, in some instances, only AIR representations may be included in the deployed personalized CTR, as both ROC AUC and PR AUC are top ranking and memory requirements are lower. In the personalized PCCVR, the Skip-gram and visual representations performed best together in terms of PR AUC. However an ADPM which utilizes only the adSformer component 302 and the learned representations component 320 also performs well. This may be because adSformer component 302 may learn a signal similar to the signal from the pretrained Skip-gram as they both encode the sequential nature of sequences of listing IDs.

The personalized CTR and PCCVR models may differ in the pretrained representation component 320's optimal configuration. This may be because a user may have different intentions during the user's particular browsing experience with an E-commerce website. For example, a given user shown an ad impression is likely to be earlier in the purchase funnel and the given user's intent while clicking (CTR prediction) may be focused around shopping for inspiration or price comparisons, so the AIR representation of the pretrained representations may be more important. Post-click, the given user's purchase intent (PCCVR prediction) may be more narrowly focused on stylistic variations and shipping profiles of a candidate listing, so the visual signal from the image embedding of the pretrained representations component may be more important.

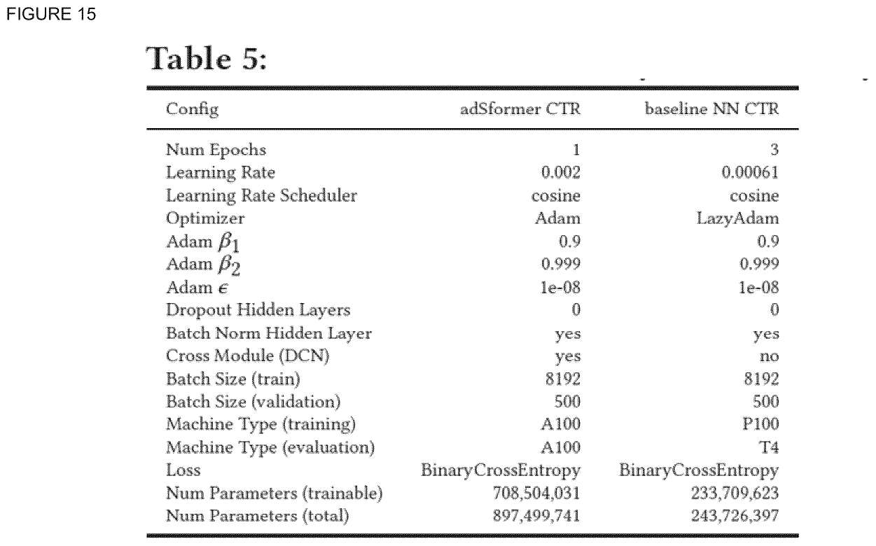

Table 5 of FIG. 15 provides examples of hyperparameters and other machine learning choices for the personalized CTR model as well as for its baseline, the non-personalized baseline model described above. The personalized PCCVR may have similar settings.

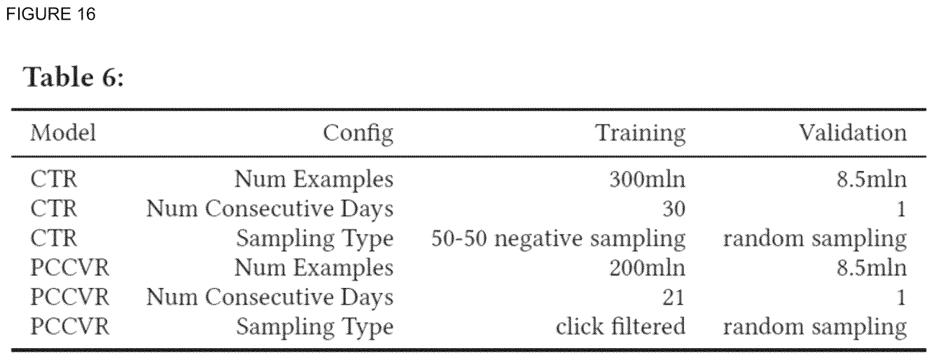

Table 6 of FIG. 16 provides example dataset choices for the winning personalized CTR and PCCVR. For the personalized CTR model, 50 percent of non-clicked impressions in the training dataset were sampled, and a random sampling was performed for the validation set, so that validation and test sets are representative of real-world production data. The personalized PCCVR model may be trained on clicked impressions but evaluated on a representative test sample, similarly to the personalized CTR model.

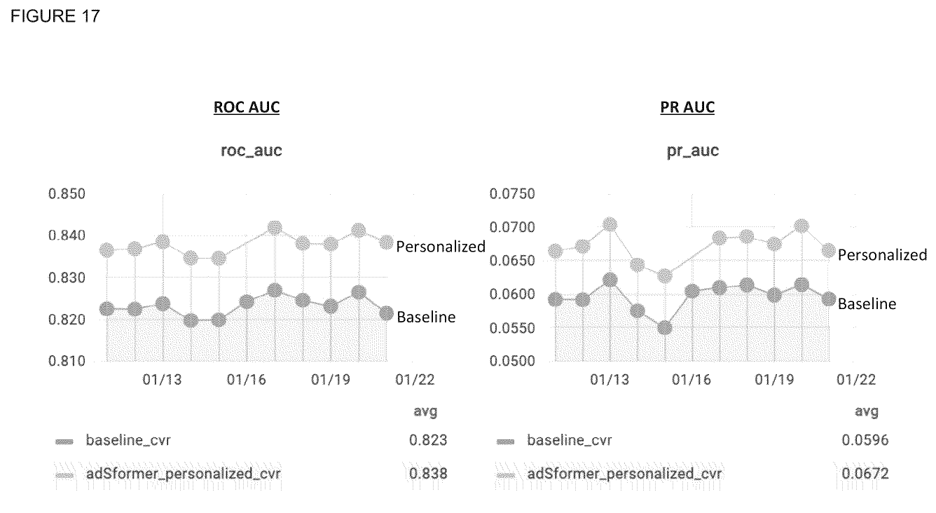

The personalized CTR and PCCVR models may be trained daily. FIG. 17 provides an example of the PR AUC and ROC AUC lift for the personalized PCCVR as compared to the non-personalized PCCVR baseline model across a test period of ten days in January of 2023. This data demonstrates that ADPM performed better than the baseline models for the test period.

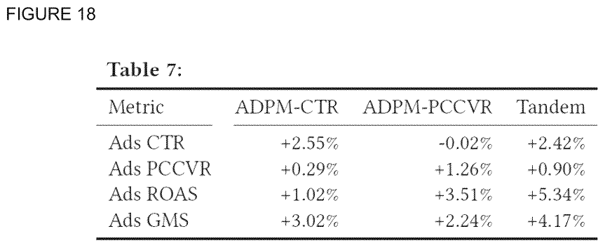

The personalized CTR and PCCVR models may also be tested in online A/B tests (e.g., split tests or bucket tests). Example results are depicted in Table 7 of FIG. 18. Compared to the non-personalized baseline model, the personalized PCCVR model demonstrated an increase in revenue earned for each dollar or other currency amount spent on advertising or “Return on Ad Spend” (ROAS), non-personalized PCCVR baseline model, and the total value of merchandise sold over a given period of time through an ECommerce website or “Gross Merchandised Sale” (GMS) which may exclude additional costs such as shipping costs,, refunds, etc. This may translate into an increase in orders with larger sale values at a lower cost to sellers. The personalized CTR model also shows improved engagement metrics and the personalized CTR and PCCVR models deployed in tandem for A/B test demonstrated even larger increases in ROAS and GMS when comparing to individual model contributions.

In some instances, sampling biases, such as position bias, can reduce ad ranking improvements from ADPM. A correlation can be observed between the positional rank of a shown ad and the probability of being clicked, which can lead to a feedback loop where the personalized CTR model inadvertently prioritizes certain candidates due to previous high ranking and not due to model improvement. To address this challenge, an auxiliary debiasing model may be included in the personalized CTR model. For example, as shown in FIG. 8B, the CTR architecture may include a Debias Tower 832A which may learn the effect of position bias on the final score during training.

In order to assign monetary value and forecast budget depletion, the output of the personalized CTR and PCCVR models, or the predicted personalized CTR and PCCVR scores, should reflect true probabilities. To address this, a calibration layer may be incorporated into each of the personalized CTR and PCCVR models. In some instances, calibration may be achieved through the parametric approach of Platt Scaling.

Although multitask learning may typically improve accuracy of tasks as well as efficiency of machine learning pipelines. However, given the robustness of the baseline CTR and PCCVR models, multitask learning, though possible, may be fairly complex. As such, the approaches described herein relate to separately training individual personalized CTR and PCCVR models.

Introducing recent and even real time sequences of user actions into a production training and serving path includes infrastructure challenges, and a heavy investment in streaming architecture. As such, a low latency streaming system powered by Kafka PubSub for writing interaction event logs to a low latency feature store may be utilized. The logged-in and logged-out user features are made available through a scalable micro service. The fetched in-session features may be captured and preserved in training logs (e.g., stored in the storage systems 104, 106, 108) as close in time as possible to model serving (e.g., providing a user with results), which minimizes skew between training and serving feature set. The server 102 may therefore use memcache to cache model scores thereby reducing latency and volume to downstream feature fetching and model inference services. The key used to write and read requests may be updated to include user and browser ID (for logged-out users). The real-time nature of the user action sequences may require that either the cache is removed or that the expiration TTL is lowered dramatically. At scale, latency and cloud cost surges due to increased volume to downstream services may be a concern.

The features described herein may provide a scalable general approach to ads personalization from variable-length sequences of recent user actions. Further experiments may improve the results including, for example, creating other architectures for the adSformer component 302, adding pretrained graph representations to the pretrained representations component 318, as well as improving image, text, and multimodal representations for the pretrained representations component 318. In addition, ADPM may be used to personalize models used for the ads candidate retrieval 710, the pretrained representations may be used to encode the input sequence representation 306 and/or the target listing representation 308, to encode action types in addition to listing IDs 3. Encode not just the Listing Ids but also the action types of the user behavioral data, and provide better time-based encoding and better masking using the transformer encoder. In addition, GPU optimizations (e.g., parallelism of GPU accelerated hardware) may be used to accelerate the ADPM training as ADPM requires significant memory and cloud computing resources. In addition, ADMP may even be pretrained as its own model separate from the downstream task and there after fine-tuned according to the downstream task of a particular downstream model (e.g., such as CTR and PCCVR models).

Performing real-time inference for personalizing CTR and PCCVR models for a full set of ad listings would be prohibitively expensive, as noted above, the ads candidate retrieval 710 may be used. This may select a subset of candidate listings, e.g. 600 or more or less, to re-rank using the personalized CTR and PCCVR models. The ads candidate retrieval 710 may employ a hybrid lexical and pretrained representation-based retrieval system, designed to produce maximally relevant results for all types of user queries. In a first retrieval pass, the baseline CTR and PCCVR models may be batch inferenced offline daily to provide “static” CTR and PCCVR models. The output of these static CTR and PCCVR models, or the predicted scores, along with every listing's title and tags and in some instances, the ad budget remaining for each listing's campaign, may be indexed in a sharded inverted index search database running Apache Solr2.

At query time, a predetermined number of listings, such as 1000 or more or less, may be batch together based on title, tag matching, and with budget remaining. A ranking score may be calculated. For instance, listings may also be boosted in the rankings (e.g., a higher ranking score) by a taxonomy matching prediction score, obtained from a separately trained and batch inferenced Bidirectional Encoder Representations from Transformers (BERT) model, as well as additional business logic which may be specific to the particular use case and users of the website. For instance, some listings may be ranked higher based on location information. For example, international listings which correspond to a country in which a user's computing device is located may be ranked higher than other listings which do not correspond to that country. In other instances, listings with certain characteristics may be ranked higher than other listings during certain periods of time. For example, during certain times of year, winter coats may be ranked higher than beachwear. As another example, listings that are “on sale” may be ranked higher immediately before, during, and after holiday periods.

Representations may be leveraged from a two-tower (e.g., query and listing towers, with textual inputs only) model built for organic search retrieval. Multimodal AIR representations may also be used. Given the trained two-tower model, the query tower may be hosted online for live inference and batch inference the representations from the listing tower, which may be indexed into an Approximate Nearest Neighbor (ANN) database (e.g., of the storage systems 104, 106, 108). However, when adopting off-the-shelf ANN solutions for an ads use case, may result in problems as the index may become stale in a short period of time as sellers' budgets deplete throughout the day. Currently, ANN options on the market do not allow for filtering on attributes that change with such high frequency. In this regard, integrated filtering may be incorporated directly into the ANN database.

Extensive offline experiments and ablation studies may be used to evaluate the various models for a given website. For example, the effect of the vocabulary size effect may be studied when encoding the representations of listing ID sequences. Example results are provided in Table 8 of FIG. 18. All three components of the ADPM, the adSformer component 302, the pretrained representations component 318, and the learned representations component 320, use the same vocabulary. As can be seen, increasing the vocabulary size K after a certain point provides very little benefit.

Offline comparison of numbers may vary for the same model variant due to variability inherent in sampled datasets. For reproducibility, Table 9 provides an example set of hyperparameters and other machine learning choices for a personalized CTR model trained using different vocabulary (e.g., personalized CTR model using vocabulary K=750K, personalized CTR model using vocabulary K=600K) which performed best in offline testing of historical datasets.

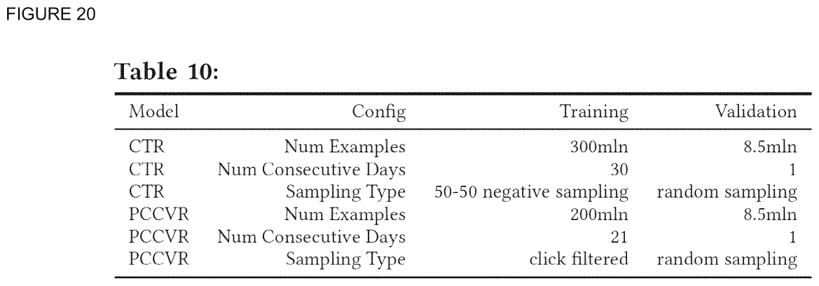

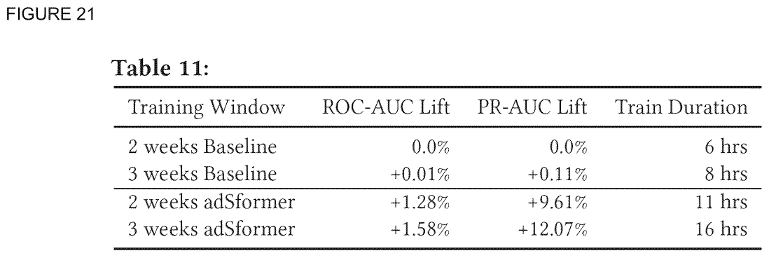

Table 10 of FIG. 20 provides dataset choices for the personalized CTR and PCCVR model. In this example, for the personalized CTR model, 50 percent of non-clicked impressions were sampled in the training dataset. A random sampling was then performed for the validation set, so that validation and test sets are likely to be representative of real-world production data. The personalized PCCVR model was trained on clicked impressions but evaluated on a representative test sample, similarly to the personalized CTR model. Furthermore, Table 11 of FIG. 21 illustrates gains in performance from increased training dataset size after including the ADPM in a personalized PCCVR model.

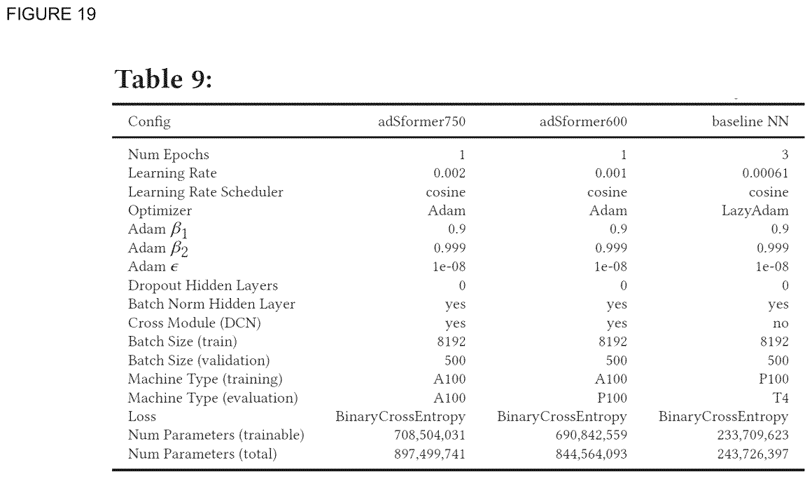

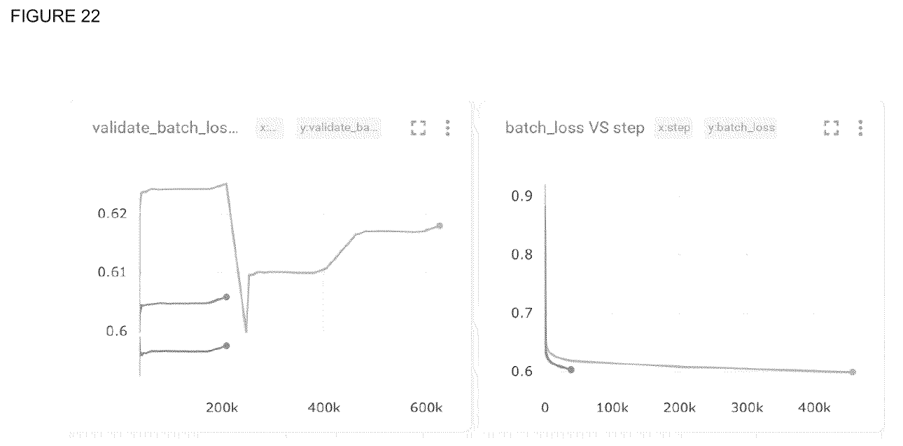

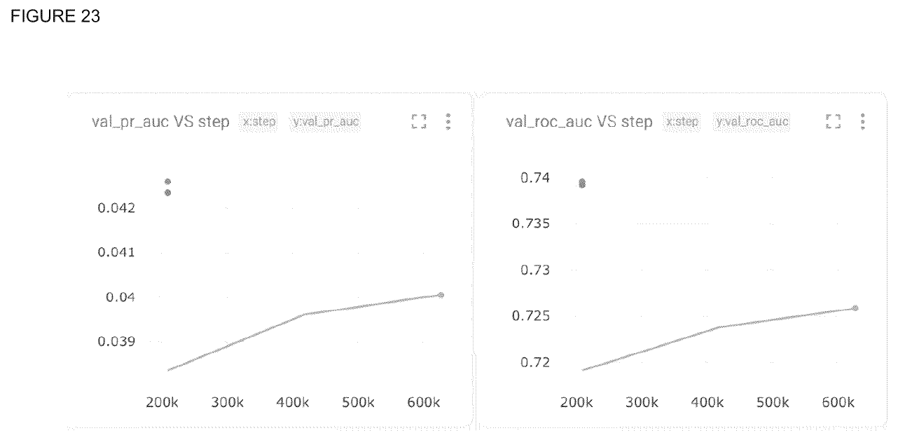

To determine optimal hyperparameters, random search, deep learning expert manual selection, and Bayesian hyperparameter search may be combined, depending on the hyperparameter of interest. Training dynamics curves may be visualized in Comet ML to guide model choices. For example, FIG. 22 provides train and validation loss curves generated using Comet ML. As can be seen, different personalized CTR models which utilize listing ID vocabularies of 750K and 600K respectively and trained for one epoch, may achieve slightly lower training losses and significantly lower validation losses when compared to the baseline CTR model trained for three epochs. Table 9 of FIG. 19 gives an example configuration for these three compared models (e.g., personalized CTR model using vocabulary K=750K, personalized CTR model using vocabulary K=600K, and the baseline CTR model). Table 8 of FIG. 18 depicts final metric lifts and training times achieved on the same train and validation datasets (depicted in Table 10 of FIG. 20). FIG. 23 depicts a comparison of AUC and PR AUC curves the personalized CTR model as compared to the baseline CTR model, and visually depicts the lift achieved by the different personalized CTR model variants in validation AUC metrics.

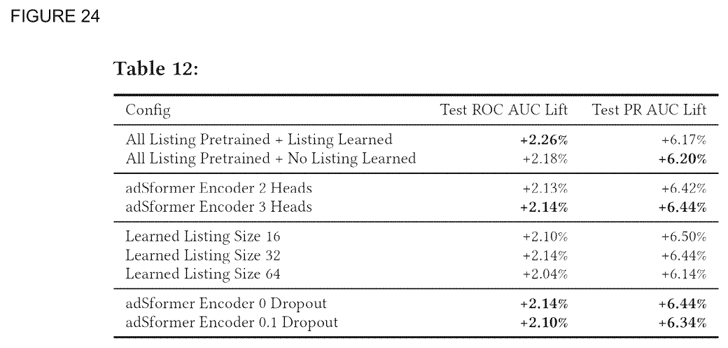

Additional ablation studies may be used to vary multiple hyperparameters, for example the number of heads in the adSformer component 302 and the listing representation size for the learned representations component 320. For instance, Table 12 of FIG. 24 suggests that removing the average pooled learned listing representation from ADPM in the personalized PCCVR model leads to a drop in ROC AUC but an increase in PR AUC. As there is a better understanding of online to offline correlations between offline test ROC AUC and online PCCVR, the increased ROC AUC model may be selected or used. Lowering the size of the learned listing representations for the learned representations component 320 has a similar effect. The addition of one head to the adSformer component 302 increases both metrics and so does the removal of dropout.

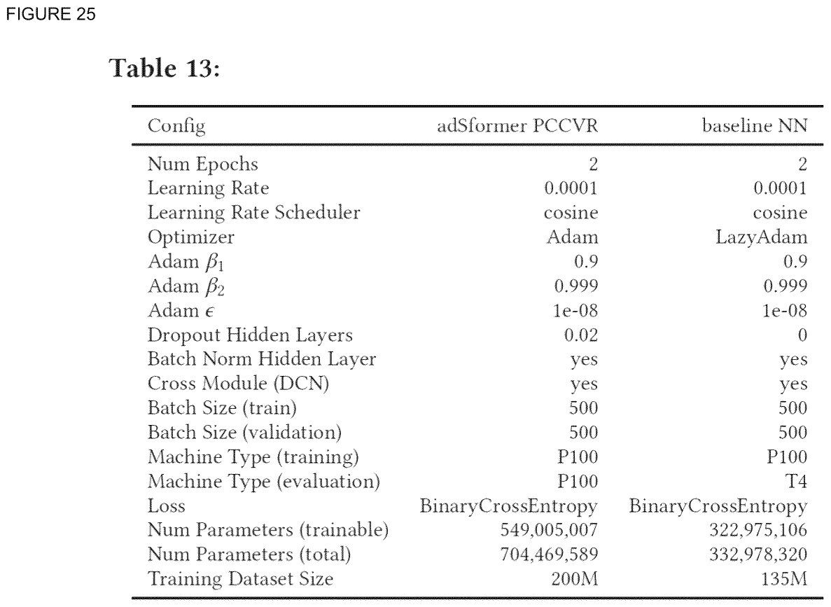

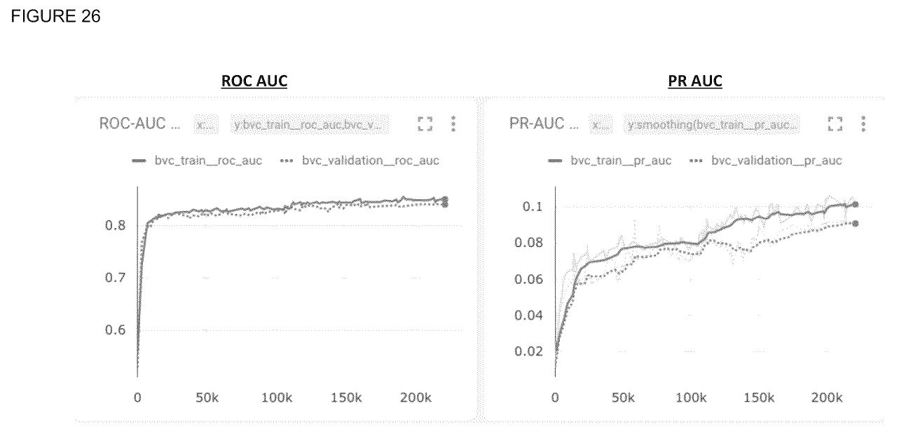

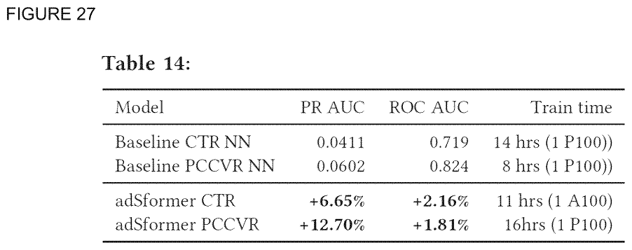

Similar ablation studies may be performed for the personalized PCCVR model. Table 13 of FIG. 25 depicts the final hyperparameter settings for the personalized PCCVR model. In this example, the baseline NN or baseline neural network refers to the baseline PCCVR model. FIG. 26 depicts a comparison of ROC AUC and PR AUC per step. In this example, the steps of the “x-axis” represent training. This FIGURE thus demonstrates how the evaluation metric improves after each training step or rather, how the model improves at the evaluation task (e.g., that the training is effective to improve the model). In addition, Table 14 of FIG. 27 presents another set of the personalized CTR and PCCVR offline performance results against the baseline CTR and PCCVR models (e.g., baseline CTR NN or baseline NN PCCVR). In addition to position debiasing, other selection biases, such as the conditionality of our PCCVR prediction target on the CTR target, may be used. The personalized PCCVR model predicts P(yPCCVR=1|yCTR=1,x). This effectively ignore the sample space of non-clicked purchased items in the personalized search ads space or P(yPCCVR=1|yCTR=0,x). In preliminary evaluations of potential explicit treatment for this selection bias, for example by using an inverse propensity weighting in a multitask CTR-PCCVR formulation, the metric improvements do not sufficiently justify an increase in machine learning system complexity.

After the baseline CTR and PCCVR models are trained, the raw logits may be used as a feature to the calibration layer. The calibration layer may be a simple logistic regression model trained on the validation set reflecting the production or real world data. The calibration layer may learn a single parameter A and bias term B, and output P:

$$P ( x ) = \frac{1}{1 + exp ( - ( A f ( x ) + B ) )} .$$

The calibration mapping function may be isotonic (monotonically increasing), preserving the relative ordering of predictions. The AUC should be identical between the personalized (trained) and baseline models. Miscalibration may be evaluated by monitoring the Expected Calibration Error (ECE) and Normalized Cross Entropy (NCE). The ECE may provide a measure of the difference in expectation between confidence and accuracy. The ECE may be approximated by partitioning predictions into M equally-spaced bins and taking the weighted average of the difference between each bins' accuracy and confidence.

In one example, the visual representations model of the pretrained representations component 318 may be trained on the following four datasets/classification tasks: listing images to top level taxonomy, listing images to fine grained taxonomy, listing images to seller-input primary color, user-uploaded review photos to fine grained taxonomy. In this example, for the top level taxonomy and primary color tasks 16,000 images may be sampled to provide sets of 15 labels each. For the fine grained taxonomy, 200 images may be sampled to provide a set of 1000 taxonomy nodes. The final convolutional layer of the EfficienetNetB0 backbone of the visual representations model of the pretrained representations component 318 may be replaced with a 256-dimension layer to output representations of the same size. The visual representations model of the pretrained representations component 318 may then be trained by first freezing the backbone and training only classification heads for one epoch using a 0.001 learning rate, and then unfreezing the final 50 layers of the backbone and training for an additional 8 epochs using the same learning rate. Adam optimizer with values of 0.9, 0.999 and 1.0e−7 for betal, beta2 and epsilon, respectively, may be used.

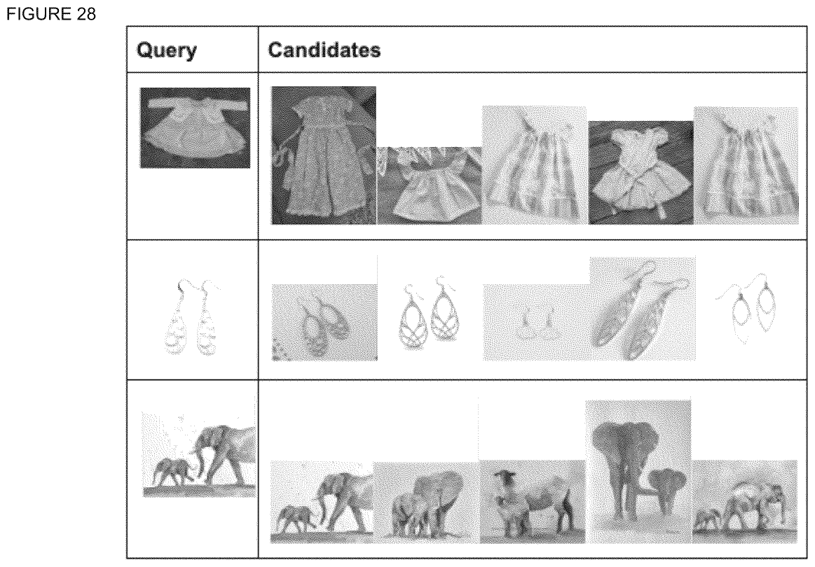

Because the listing-to-listing experience does not require real-time predictions, a daily batch inference pipeline may be implemented to generate visual representations for all listings. This pipeline may first extract a primary image for each listing. A primary image may be a first image displayed in a listing or a particular image which has been designated as a primary image (e.g., by a seller when creating or editing the listing). These primary images may then be passed forward through the frozen visual representation model to generate representations for each listing. Representations for all listings may then be saved to a scalable key-value store. Representations are also filtered down by active ad campaigns. These candidate representations may be indexed into an Approximate Nearest Neighbor (ANN) inverted file (IVF) index. The IVF may approximate a nearest neighbor search by first splitting the representation space to some number of clusters, and at inference time only searching the “K” nearest clusters (in this instance, “K” represents an integer representing a desired number of results). With this, a large space of representations may be more efficiently searched. FIG. 28 represents three sets of example results (candidates) for three different image searches (queries) for a nearest neighbor search using the visual representations described herein.

In some instances, the visual representation model may also enable a “search by image” shopping experience. For example, users may search by entering an image for a query for listings, for example, by using photos taken with the users' phones rather than a text-based query (e.g., as in the example of “jacket” described above). The dataset sampler 510 may be used to train on an additional task to classify review photos to their corresponding listing's taxonomy. As an example, review photos may include photos of purchased items taken by users and attached to reviews of such purchased items. These images may serve as a proxy for user-taken query images.

The search by image experience may require generating a visual representation of the query image in real time. To increase efficiency, the visual representation model may be hosted on a computing device (e.g., server 102) that also has a GPU hardware accelerator attached as this may increase linear algebra operations related to CNNs used in image models. Similarly to the visually similar ads module, the candidate representations of the search by image retrieval system may be pre-computed by generating representations for primary listing images on a recurring basis. However, ads are being served as well as listing results, the ANN may be indexed with the full inventory of active listings (e.g., 100 million listings or more). At query time, the user-submitted image is inferenced on the visual representation model to compute the representation, which may be used to search the ANN index for a desired number of visually similar listings.

In addition to parameterizing the ADPM, the AIR representations generated by the pretrained representations component 318 may be used to retrieve recommendation-style ads for listing-to-listing requests, across various types of webpages. For example, a sash or other arrangement of sponsored listing recommendations (e.g., ads) appearing at the bottom of a listing results page may be generated using the AIR representations. In listing-to-listing requests candidates may be retrieved using a query representation generated from the features of the viewed or source listing.

As an example, the representation model may be trained using 30 million click pairs identified using a window of 45 days of user behavior data. The Adam optimizer, with a learning rate, betal, beta2, and epsilon values of 0.0001, 0.9, 0.999, and 1e−7, respectively, may also be used. A batch size of 4096 and 1500 negative labels may be sampled to calculate the loss.

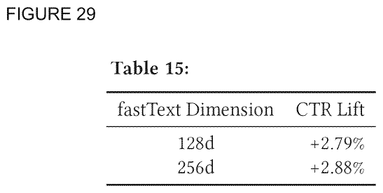

Online A/B experiments may be run against a control such as representations extracted from the listing tower of a model trained on organic search purchases (a less relevant objective for ads optimizing for click engagement). In this regard, AIR representations may be evaluated against such organic purchase optimized representations. For instance, experiments may involve testing two versions of AIR representations where text features were encoded using a fasttext encoder of either size 128d or 256d. As shown in table 15 of FIG. 29, the two versions may be tested to measure the effect of different dimensions of the input text representations, 128d and 256d, since the text representation lookup table makes for the majority of trainable parameters in the pretrained listing representations model.

In order to generate the aforementioned text representations, raw text inputs may first be preprocessed to standardize casing and punctuation, mask stop-words and numbers, and remove extraneous spaces and symbols. These text inputs may be generated by concatenating text information from listings including, for example, titles, tags, descriptions, etc. “Tokens” may be used to represent individual words or subwords. For example, “more and more fun” may include 4 words and 3 word tokens (more, and, fun). As another example, “jumping” may include 1 word and 2 subword tokens (“jump” and “ing”). To reduce the size of the final lookup table, tokens which have less than 10 occurrences may be discarded. At the same time, to maintain relevance to the ad use case, tokens which appeared at least once in the last 30 days of ad interactions, even if they occur less than 10 times in the data, may be kept. The model used to generate text representations may be trained using a sliding window of a fixed number of words (e.g., 5 words) at a time and predicting the probability of seeing the surrounding words in the window. The model may therefore output a text embedding for every word. Those text embeddings may then be used to encode text in other models such as the AIR model for generating AIR representations by averaging the embeddings of a sentence or phrase.

As an example, the Skip-gram word representations for the pretrained representations component 318 may be trained for five epochs. In this example, a learning rate of 0.05, a context window of five, and a minimum and maximum character n-grams lengths of three and six, respectively, may be used. The training may use negative sampling with five sampled negatives. While both 128 and 256 dimension representations may be used, in some instances, the larger representations may perform slightly better in most downstream use cases. However, the number of trainable parameters of the lookup table grows significantly with larger representations, and thus requires more expensive infrastructure to fine-tune during training of downstream tasks, and in particular with the pretrained CTR model.

An objective of the Skip-gram model of the pretrained representations component 318, may be to predict, given a listing li, the probability that another listing lᵢ₊ⱼ will be observed within a fixed-length contextual window. The probability p(lᵢ₊ⱼ|lᵢ) may be defined mathematically according to the softmax formula:

$$p ( {l}_{i + j} \vert {l}_{i} ) = \frac{exp ( {v}_{{l}_{i}}^{T} {v}_{{l}_{i + j}}^{′} )}{{\sum }_{k = 1}^{\vert V \vert} exp ( {v}_{{l}_{i}}^{T} {v}_{{l}_{k}}^{′} )}$$

In this example, vₗ and vᵣ are the input and output vector representations of a listing l, respectively, k is an index value, and V is the set of listings used to train the pretrained listing representations model which generates the Skip-gram representations.

In this example, two months' worth of user sessions may be used for the Skip-gram word representations for the pretrained representations component 318. Sessions that included a purchase may be upsampled at a rate of 5:1. The representation dimension d=64 noted above may be used as higher dimensions may tend to improve representation quality with diminishing returns and with tradeoffs in model training and inference cost. A context window size of five may also be used. Increasing the window size may have a positive impact for negative sampling models, but may also have mixed results for hierarchical softmax models

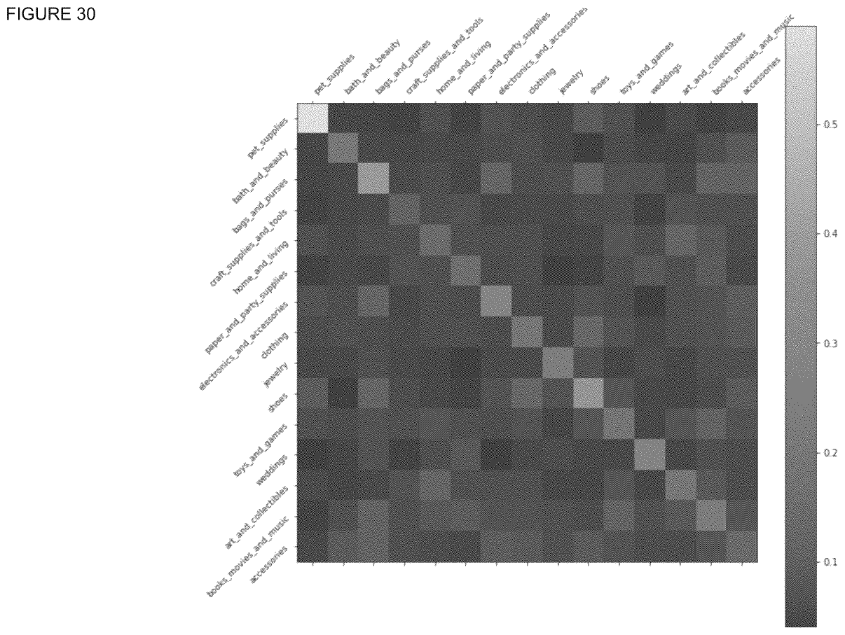

Cosine similarity of groups of listings segmented by various listing attributes may also be used to observe Skip-gram representation quality and to better understand what signals these representations are learning. For example, listings which are co-viewed in a session are likely to belong to the same taxonomy node, so listings with the same taxonomy would be expected to have a higher cosine similarity than those with different taxonomies. FIG. 30 demonstrates how Skip-gram representations learned as described herein (e.g., using the hierarchical softmax approach) capture various listing taxonomy attributes.

To evaluate the Skip-gram representations, batch data inference jobs with Apache Beam and Dataflow to compute the search ranking and attribute cosine similarity metrics, which may be visualized in GOOGLE's Colab notebooks.

The features described herein may provide for the generation of short-term user representations based on a diversifiable personalization module. Because the ADPM relies on a sliding window of most recent user actions, the resulting personalized representations and ranked ads or search results generated for each individual user may have the most relevance to that individual user at that time. In this regard, ADPM's use of a plurality of different components, provides diversity of representations which improves overall performance of predictions of future user behavior. For instance, when used in conjunction with various downstream models, such as CTR and PCCVR, these models outperform the CTR and PCCVR prediction baselines (e.g., without ADPM) by +2.66% and +2.42%, respectively, in offline Area Under the Receiver Operating Characteristic Curve (ROC-AUC), as well as in online metrics. In addition, although marked improvements in CTR and PCCVR predictions, because ADPM is highly configurable, it can be scaled to many different types of downstream tasks while at the same time introducing a per-model customization without sacrificing performance.

Unless expressly stated otherwise, the foregoing examples and arrangements are not mutually exclusive and may be implemented in various ways to achieve unique advantages. These and other variations and combinations of the features discussed herein can be employed without departing from the subject matter defined by the claims. In view of this, the foregoing description of exemplary embodiments should be taken by way of illustration rather than by way of limitation.

The examples described herein, as well as clauses phrased as “such as,” “including” and the like, should not be interpreted as limiting the subject matter of the claims to any specific examples. Rather, such examples are intended to illustrate possible embodiments. Further, the same reference numbers in different drawings can identify the same or similar elements. The processes or other operations may be performed in a different order or concurrently, unless expressly indicated otherwise herein.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. As used in this document, “each” refers to each member of a set or each member of a subset of a set.

To aid the Patent Office and any readers of any patent issued on this application in interpreting the claims appended hereto, Applicant notes that it does not intend any of the appended claims or claim elements to invoke 35 U.S.C. 112(f) unless the words “means for” or “step for” are explicitly used in the particular claim.

1. A computer-implemented method comprising:
identifying, by one or more processors of a server computing device, a set of user actions by a specific user within a sliding window of time;
generating, by the one or more processors, a first representation for the set of user actions using an encoder component of a personalization module;
generating, by the one or more processors, a second representation for the set of user actions using a pretrained representations component of the personalization module;
generating, by the one or more processors, a third representation for the set of user actions using a learned representations component of the personalization module;
using, by the one or more processors, the personalization module to combine the first representation, second representation and the third representation to generate a short-term personalized representation for the specific user; and
providing, by the one or more processors, a set of results for display to the specific user based on the short-term personalized representation.

2. The method of claim 1, wherein the set of user actions include one or more of search queries, item favorites, listing views, items added to a cart of the specific user, or one or more past purchases.

3. The method of claim 1, further comprising:
inputting the short-term personalized representation into one or more personalized downstream models in order to generate a value; and
ranking the set of results based on the value, and wherein the ranked set of results is provided for display to the specific user.

4. The method of claim 3, wherein the one or more personalized downstream models includes a first model that generates a predicted probability that a particular listing will be clicked.

5. The method of claim 4, wherein the one or more personalized downstream models further include a second model that generates a predicted conditional probability that a good or service represented by a listing will be purchased.

6. The method of claim 1, wherein the personalization module is implemented as a Tensorflow Keras layer.

7. The method of claim 1, further comprising determining a length of the sliding window based on a location of the specific user.

8. The method of claim 1, further comprising determining a length of the sliding window based on a type of listing selected by the specific user within the sliding window.

9. The method of claim 1, wherein the sliding window is no more than 1 hour.

10. The method of claim 1, wherein the set of user actions is limited in number according to a maximum sequence length.

11. The method of claim 1, wherein the encoder component includes a transformer encoder.

12. The method of claim 11, wherein the encoder component is implemented as an importable Keras layer which encodes sequences of listings.

13. The method of claim 1, wherein the pretrained representations component is configured to encode sequences of user actions within the sliding window.

14. The method of claim 1, wherein the pretrained representations component is configured to encode sequences of search queries within the sliding window as text representations.

15. The method of claim 14, wherein the text representations are Skip-gram text representations.

16. The method of claim 1, wherein the pretrained representations component is configured to encode sequences of listing identifiers within the sliding window as multimodal representations.

17. The method of claim 1, wherein the pretrained representations component is configured to encode sequences of listing identifiers within the sliding window as visual representations.

18. The method of claim 1, wherein the pretrained representations component is configured to encode sequences of listing identifiers within the sliding window as Skip-gram listing representations.

19. The method of claim 1, wherein the learned representations component is configured as a look-up table.

20. A computer system configured to generate personalized results, the computer system comprising:
memory configured to store a set of user actions for a specific user within a sliding window of time; and
one or more processors operatively coupled to the memory, the one or more processors being configured to:
generate a first representation for the set of user actions using an encoder component of a personalization module;
generate a second representation for the set of user actions using a pretrained representations component of the personalization module;
generate a third representation for the set of user actions using a learned representations component of the personalization module;
use the personalization module to combine the first representation, second representation and the third representation to generate a short-term personalized representation for the specific user; and
provide a set of results for display to the specific user based on the short-term personalized representation.
